(19) United States
(12) Patent Application Publication
(10) Pub. No.: US 2008/0309662 A1
(43) Pub. Date: Dec. 18, 2008

(54) Example Based 3D Reconstruction

(76) Inventors: Tal Hassner, Tel-Aviv (IL); Ira Kemelmacher, Tel-Aviv (IL); Ronen Basri, Rehovot (IL)

Correspondence Address: DANIEL J SWIRSKY, 55 REUVEN ST., BEIT SHEMESH, 99544, IL

(21) Appl. No.: 12/096,909

(22) PCT Filed: Dec. 14, 2006
(86) PCT No.: PCT/IL06/01442

§ 371 Date: Aug. 27, 2008

Related U.S. Application Data
(60) Provisional application No. 60/750,054, filed on Dec. 14, 2005.
(60) Provisional application No. 60/838,163, filed on Aug. 17, 2006.

(51) Int. Cl. G06T 15/00

(52) U.S. Cl. 345/419

(57) ABSTRACT

A method includes reconstructing the 3D shape of an object appearing in an input image using at least one example objects of a collection of example 3D objects and their colors.

### CROSS-REFERENCE TO RELATED APPLICATIONS

This application claims benefit from the following U.S. Provisional Patent Applications: 60/750,054, filed Dec. 14, 2005, and 60/838,163, filed Aug. 17, 2006, both of which are hereby incorporated in their entirety by reference.

### FIELD OF THE INVENTION

The present invention relates to the reconstruction of 3D shapes for objects shown in 2D images and colorization of 3D shapes.

### BACKGROUND OF THE INVENTION

In general, the problem of 3D reconstruction from a single 2D image is ill posed, since different shapes may give rise to the same intensity patterns. To solve this, additional constraints are required. Existing methods for single image reconstruction commonly use cues such as shading, silhouette shapes, texture, and vanishing points as in Cipolla et al. (Surface geometry from cusps of apparent contours. ICCV, 1995), A. Criminisi et al. (Single view metrology. IJCV, 40(2), Nov. 2000), Han et al. (Bayesian reconstruction of 3D shapes and scenes from a single image. Workshop on Higher-Level Knowledge in 3D Modeling and Motion Analysis, 2003), Horn (Obtaining Shape from Shading Information. McGraw-Hill, 1975) and Witkin Recovering surface shape and orientation from texture. AI, 17(1-3):17-45, 1981). However, these methods restrict the allowable reconstructions by placing constraints on the properties of reconstructed objects (e.g., reflectance properties, viewing conditions, and symmetry).

Other approaches explicitly use examples to guide the reconstruction process. One approach, as given by Hoiem et al. (Automatic photo popup. SIGGRAPH, 2005) and Hoiem et al. (Geometric context from a single image. ICCV, 2005), reconstructs outdoor scenes assuming they can be labeled as “ground,” “sky,” and “vertical” billboards.

A second notable approach, as given by Atick et al. (Statistical approach to shape from shading: Reconstruction of three-dimensional face surfaces from single two-dimensional images. Neural Computation, 8(6): 1321-1340, 1996), Blanz et al. (A morphable model for the synthesis of 3D faces. SIGGRAPH, 1999), Dovgard et al. (Statistical symmetric shape from shading for 3D structure recovery of faces. ECCV, 2004) and Romdhani et al. (Efficient, robust and accurate fitting of a 3D morphable model. ICCV, 2003) for example, makes the assumption that all 3D objects in the class being modeled lie in a linear space spanned using a few basis objects. This approach is applicable to faces, but it is less clear how to extend it to more variable classes because it requires dense correspondences between surface points across examples.

A major obstacle for example based approaches is the limited size of the example set. To faithfully represent a class, many example objects might be required to account for variability in posture, texture, etc. In addition, unless the viewing conditions are known in advance, it may be necessary to store for each object, images obtained under many conditions. This can lead to impractical storage and time requirements. Moreover, as the database becomes larger so does the risk of false matches, leading to degraded reconstructions.

Methods using semi-automatic tools, as given by Oh et al. and Zhang et al., are another approach to single image reconstruction, however, they require user intervention.

### SUMMARY OF THE INVENTION

There is provided, in accordance with a preferred embodiment of the present invention, a method including reconstructing the 3D shape of an object appearing in an input image, using at least one example object, when given an input image and a collection of example 3D objects and their colors.

Moreover, in accordance with a preferred embodiment of the present invention, the method may include seeking patches of the example object that match patches in the input image in appearance, producing an initial depth map from the depths associated with the matching patches, and refining the initial depth map to produce the reconstructed shape.

Further, in accordance with a preferred embodiment of the present invention, the seeking may include searching for patches whose appearance match the patches in the input image in accordance with a similarity measure. The similarity measure may be least squares.

Still further, in accordance with a preferred embodiment of the present invention, the method may include customizing a set of objects from the collection for use in the seeking. The customizing may include arbitrarily selecting a set of objects from the collection and updating the set of objects. The updating may include dropping objects from the set which have the least number of matched patches, scanning the remainder of objects in the collection to find those whose depth maps best match the current depth map and repeating the updating.

Still further, in accordance with a preferred embodiment of the present invention, the reconstructing may determine the viewing angle of the input image. The reconstructing may further include rendering at least one object from a current set of objects, viewed from at least two different viewing conditions, dropping objects from the current set which correspond least well to the input image, producing a new viewing condition based on the viewing conditions of objects which correspond well to the input image, rendering the object viewed from the new viewing condition, and repeating the steps of dropping, producing and rendering.

Still further, in accordance with a preferred embodiment of the present invention, the producing may include taking a mean of currently used viewing conditions weighted by the number of matched patches of each viewing condition. The producing may also include seeking at least one matching patch for each patch in the input image, extracting a corresponding depth patch for each matched patch, and producing the initial depth map by, for each pixel, compiling the depth values associated with the pixel in the corresponding depth patches of the matched patches which contain the pixel.

Still further, in accordance with a preferred embodiment of the present invention, the refining may include having query color-depth mappings, each formed of one of the image patches and its associated depth patch of the current depth map, seeking at least one matching color-depth mapping for each query color-depth mapping, extracting a corresponding depth patch for each matched patch, producing a next current depth map by, for each pixel, compiling the depth values associated with the pixel in the corresponding depth patches of the matched patches which contain the pixel, and repeating the having, seeking, extracting and producing until the next current depth map is not significantly different than the previous current depth map, to generate said reconstructed shape.

Still further, in accordance with a preferred embodiment of the present invention, the object of the input image may be a face, and the at least one example object may be one example object of an individual whose face is different than that shown in the input image.

Still further, in accordance with a preferred embodiment of the present invention, the reconstructing may include recovering lighting parameters to fit the one example object to the input image, solving for depth of the object of the input image using the recovered lighting parameters and albedo estimates for the example object, and estimating albedo of the object of the input image using the recovered lighting parameters and the depth.

Still further, in accordance with a preferred embodiment of the present invention, the recovering, solving and estimating may utilize an optimization function in witch reflectance is expressed using spherical harmonics. The solving may include solving a shape from shading problem, and the boundary conditions for the solving may be incorporated in an optimization function.

Still further, in accordance with a preferred embodiment of the present invention, the shape from shading problem may be linearized and the optimization function may be linearized using the example object. Unknowns in the shape from shading problem may be provided by the example object.

Still further, in accordance with a preferred embodiment of the present invention, the face of the input image may have a different expression than that of the example object. Still further, the input image may be a degraded image. The degraded image may be a Mooney face image. The input image may be a frontal image or a non-frontal image, a color image or a grey scale image.

Still further, in accordance with a preferred embodiment of the present invention, the method may include repeating the reconstructing on a second input image to generate viewing conditions of the second input image, projecting the viewing conditions onto the reconstructed shape to generate a projected image, and determining if the projected image is substantially the same as the second input image.

Still further, in accordance with a preferred embodiment of the present invention, the method may include repeating the reconstructing on a second input image to generate a second object, and determining if the second object is substantially the same as the first object.

There is also provided, in accordance with a preferred embodiment of the present invention, a method including stripping an input image of viewing conditions to reveal a shape of an object in the input image.

Moreover, in accordance with a preferred embodiment of the present invention, the method may also include performing the stripping on two input images and comparing the revealed shapes of the two input images.

There is also provided, in accordance with a preferred embodiment of the present invention, a method including providing surface properties to an input 3D object from the surface properties of a collection of example objects.

Moreover, in accordance with a preferred embodiment of the present invention, the providing may include seeking patches of the example objects that match patches in the input 3D object in depth, producing an initial image map from surface properties associated with the matching patches, and refining the initial image map to produce a model with surface properties.

Further, in accordance with a preferred embodiment of the present invention, the surface properties may be colors, albedos, vector fields or displacement maps.

There is also provided, in accordance with a preferred embodiment of the present invention, a method including having an input image and a collection of example 3D objects, calculating a shape estimate using the input image and at least one of the example objects, colorizing the shape estimate using color of at least one of the example objects to produce a colorized model, and employing the input image and the colorized model to refine the shape estimate to generate a reconstructed shape of the input image.

There is also provided, in accordance with a preferred embodiment of the present invention, a method including, given an input image, a collection of example 3D objects and their colors, using at least one of the example objects to reconstruct, for an object appearing in the input image, the 3D shape of an occluded portion of the object.

Moreover, in accordance with a preferred embodiment of the present invention, the using may include generating a 3D shape of a visible portion of the object in the input image and generating the shape of the occluded portion from the shape of the visible portion and at least one example object.

The present invention also incorporates apparatus which implements the methods described hereinabove.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of a shape reconstructor, constructed and operative in accordance with a preferred embodiment of the present invention;

FIG. 2 is a block diagram illustration of a shape estimate reconstructor, a component of the shape reconstructor of FIG. 1;

FIG. 3 is a flow chart illustration of the process performed by the shape estimate reconstructor of FIG. 2;

FIG. 4 is a schematic illustration of the configuration of patches used by the shape estimate reconstructor of FIG. 2;

FIG. 5 is a schematic illustration of a graphical model representation of the problem solved by the shape estimate reconstructor of FIG. 2;

FIG. 6 is a schematic illustration of the method used by the shape estimate reconstructor of FIG. 2 to contend with viewing conditions of images;

FIG. 7 is a block diagram illustration of a colorizer, a component of the shape reconstructor of FIG. 1;

FIG. 8 is a flow chart illustration of the process performed by the colorizer of FIG. 7;

FIG. 9 is a block diagram illustration of a refined shape reconstructor, a component of the shape reconstructor of FIG. 1;

FIG. 10 is a flow chart illustration of the process performed by the refined shape reconstructor of FIG. 9;

FIG. 11 is a graphical illustration of a comparison between lighting coefficients recovered by the refined shape reconstructor of FIG. 9 and true lighting coefficients of a set of exemplary images;

FIG. 12 is an illustration showing exemplary results produced by the shape estimate reconstructor of FIG. 2;

FIG. 13 is a block diagram illustration of an independently operating colorizer, similar to the colorizer of FIG. 7, but operating independently of the shape reconstructor of FIG. 1;

FIG. 14 is a flow chart illustration of the process performed by the independently operating colonizer of FIG. 13;

FIG. 15 is a schematic illustration of correspondence points used by the refined shape reconstructor of FIG. 9;

FIG. 16 is a graphical illustration comparing the ground truth shapes of a set of exemplary images, the shapes reconstructed for the images by the refined shape reconstructor of FIG. 9, and the shapes of the reference models used for the reconstructions;

FIG. 17 is an illustration showing exemplary results produced by the refined shape reconstructor of FIG. 9;

FIG. 18 is an illustration showing an exemplary image containing impoverished data which may be reconstructed by the refined shape reconstructor of FIG. 9;

FIG. 19 is a block diagram illustration of a recognizer, constructed and operative in accordance with a preferred embodiment of the present invention; and

FIG. 20 is a block diagram illustration of an alternative recognizer, constructed and operative in accordance with an additional preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Given a single image of an every day object, a sculptor can recreate its 3D shape (i.e., produce a statue of the object), even if the particular object has never been seen before. Presumably, it is familiarity with the shapes of similar 3D objects (i.e., objects from the same class and how they appear in images), which enables the artist to estimate its shape.

Motivated by this example, the present invention provides a method and apparatus for reconstructing a 3D shape from a 2D image without intervention by a user. The present invention utilizes example objects, which may be similar to the object shown in the input 2D image, as reference objects for the reconstruction process.

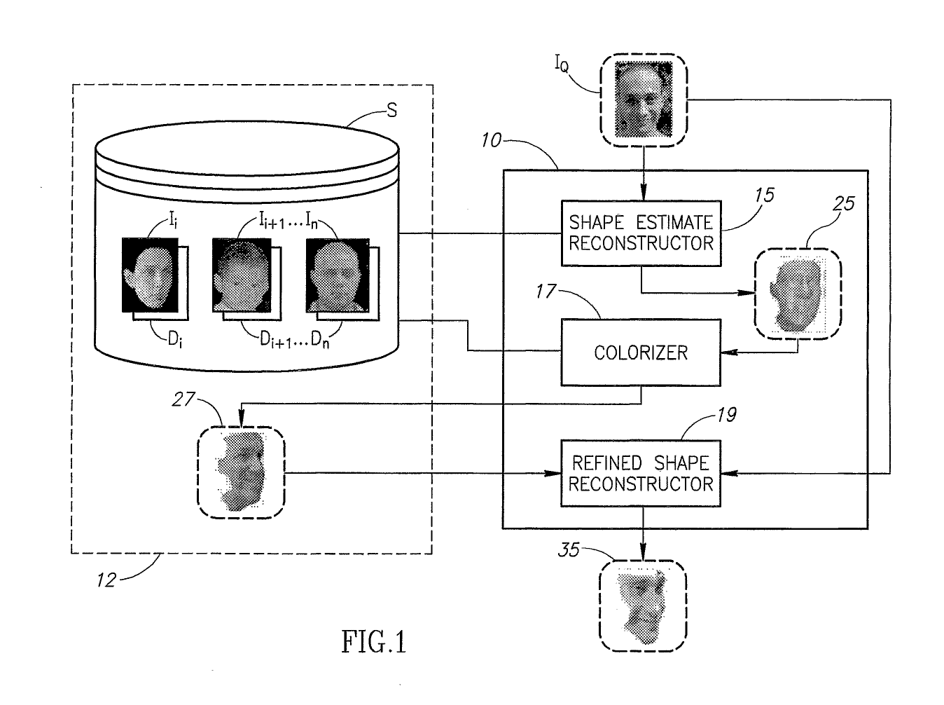

FIG. 1, reference to which is now made, shows a shape reconstructor 10, constructed and operative in accordance with a preferred embodiment of the present invention. Shape reconstructor 10 may use example objects 12 as reference objects for the shape reconstruction process provided in the present invention. As shown in FIG. 1, shape reconstructor 10 may comprise a shape estimate reconstructor 15, a colorizer 17, and a refined shape reconstructor 19. Example objects 12 may comprise an example database S, and a colorized model 27.

The input for shape reconstructor 10 may be a 2D image I_{Q}, such as the image of a face shown in FIG. 1, and example objects 12 may belong to the same class as the object shown in image I_{Q}. Accordingly, in FIG. 1, images Iᵢ . . . Iₙ in example database S are shown to be images of faces, and colorized model 27 is shown to be a model of a face. As further shown in FIG. 1, database S may also contain depth maps Dᵢ . . . Dₙ associated with each of images Iᵢ . . . Iₙ. A 3-dimensional description of each of the objects shown in images Iᵢ . . . Iₙ may thus be contained in example database S.

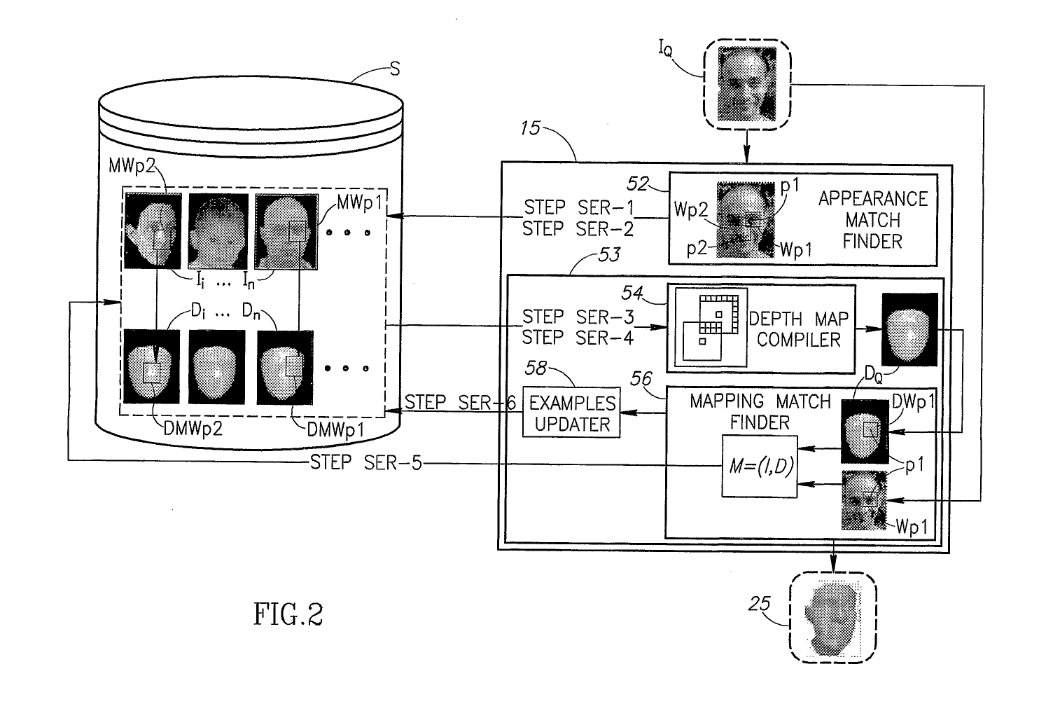

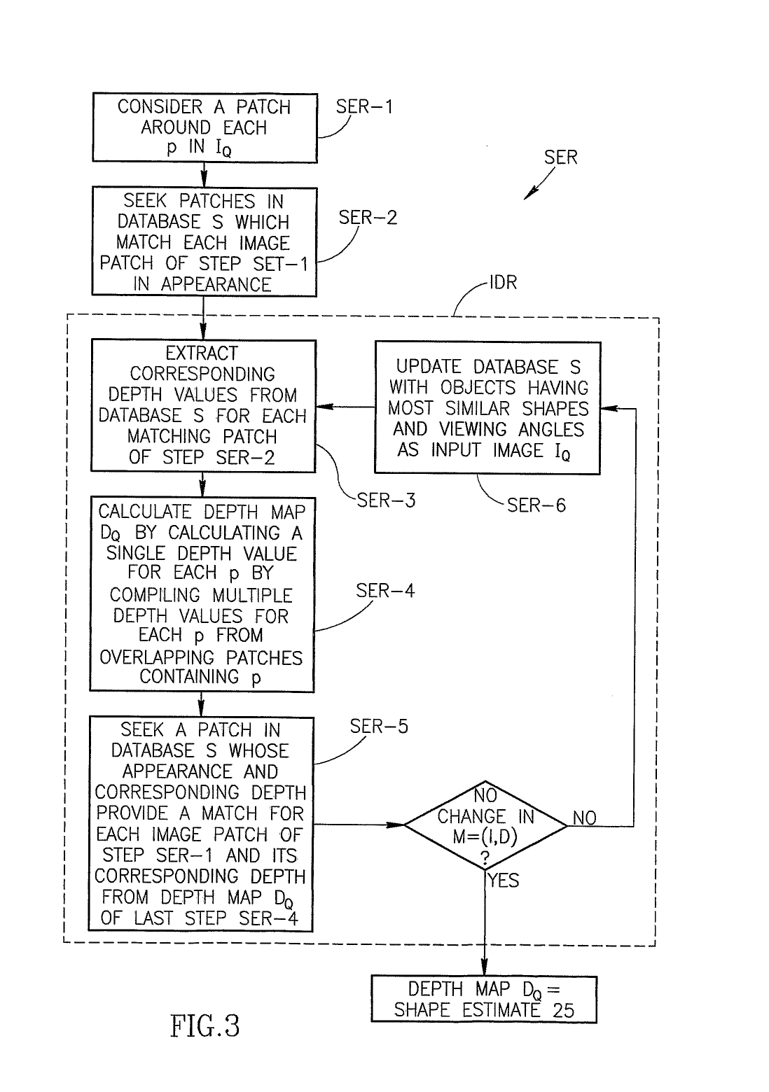

As shown in FIG. 1, shape estimate reconstructor 15 may use example database S as its source of reference objects for the construction of shape estimate 25, an initial estimate of the shape of input image I_{Q}. The operation of shape estimate reconstructor 15 will be explained later in further detail with respect to FIGS. 2 and 3.

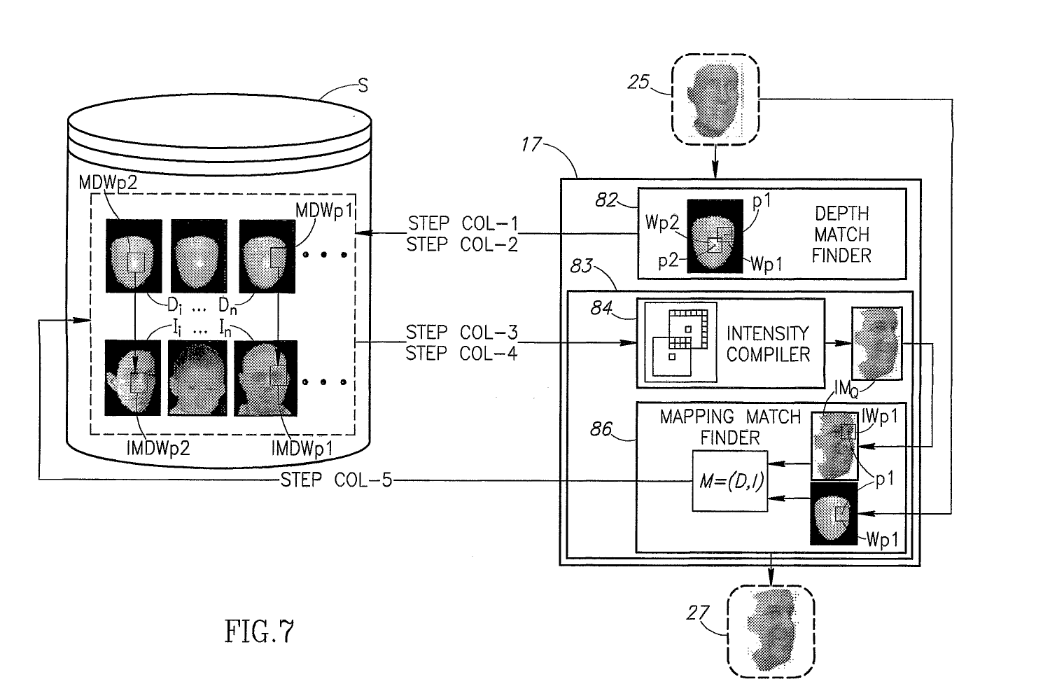

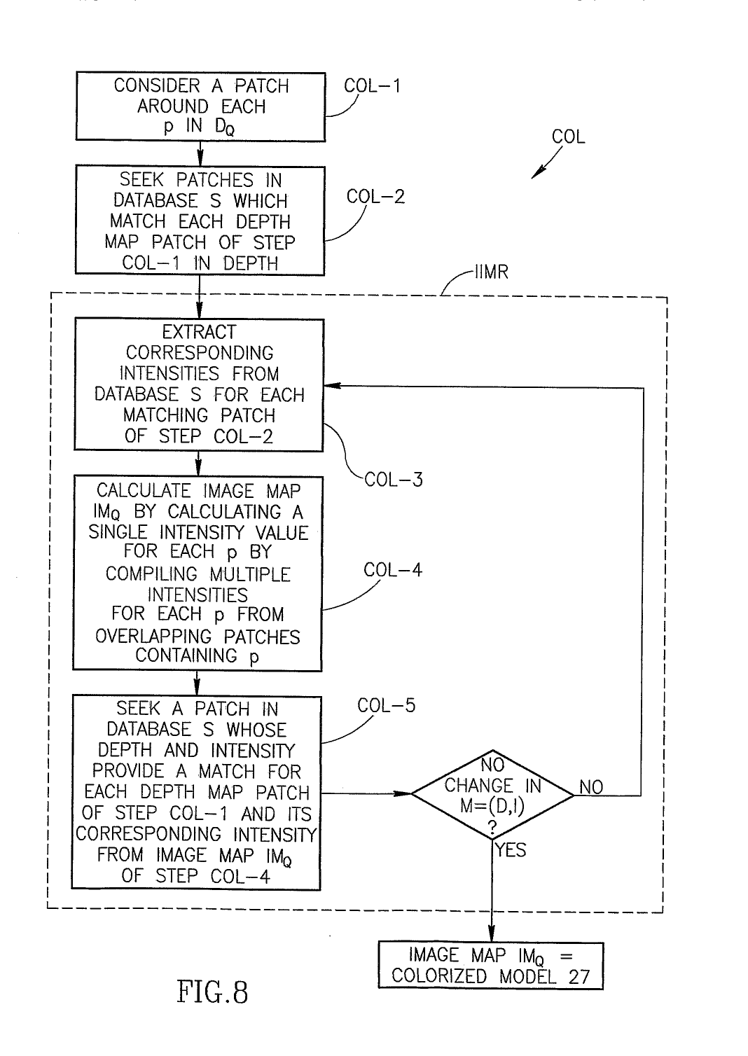

As further shown in FIG. 1, colorizer 17 may utilize example database S to produce colorized model 27 from shape estimate 25. The operation of colorizer 17 will be explained later in further detail with respect to FIGS. 7 and 8.

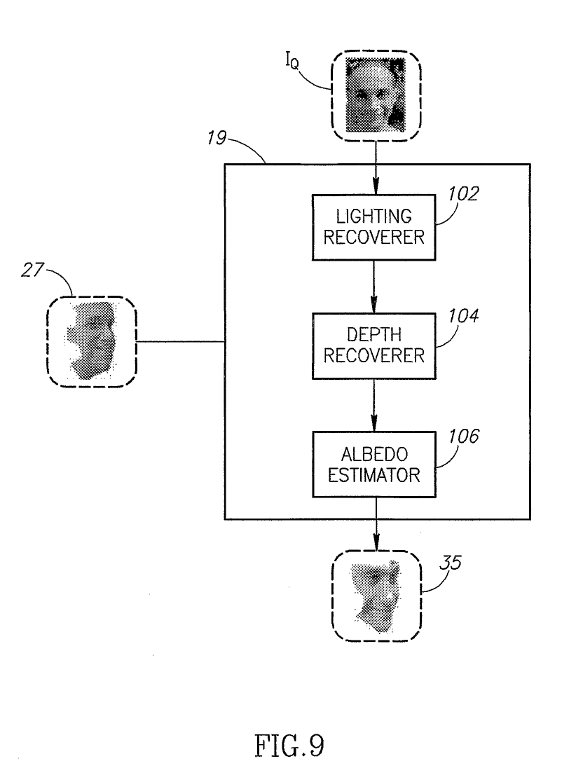

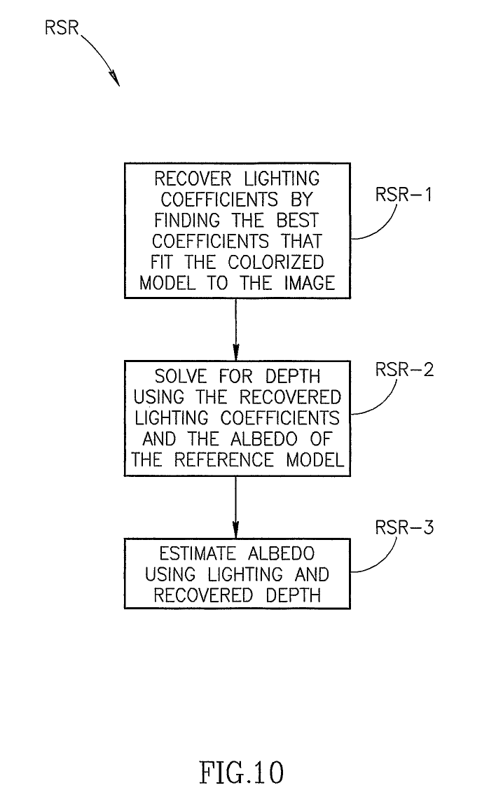

Refined shape reconstructor 19 may produce shape reconstruction 35, the final output of shape reconstructor 10. Refined shape reconstructor 19 may use only one example object as a reference object to construct shape reconstruction 35 from input image I_{Q}. As shown in FIG. 1, the single example object used by refined shape reconstructor 19 may be colorized model 27, the output of colorizer 17. The operation of refined shape reconstructor 19 will be explained later in further detail with respect to FIGS. 9 and 10.

The detailed operation of shape estimate reconstructor 15 is described with respect to FIGS. 2 and 3, reference to which is now made. FIG. 2 illustrates the operation of shape estimate reconstructor 15 for exemplary image I_{Q}. FIG. 3 is a flow chart illustrating the method steps of process SER performed by shape estimate reconstructor 15, in accordance with the present invention, to construct shape estimate 25 for the object shown in image I_{Q}.

In accordance with the present invention, shape estimate reconstructor 15 may determine depth D_{Q} for a query image I_{Q} by using examples of feasible mappings from intensities to depths for other objects of the same class whose depths D are known. As explained previously with respect to FIG. 1, these mappings M of intensities to depths may be given in example database S={(Mᵢ}ᵢ₌₁ⁿ={(Iᵢ,Dᵢ)}ᵢ₌₁ⁿ, where Iᵢ and Dᵢ are the image and the depth map, respectively, of an object from the same class as the object shown in image I_{Q}. In accordance with the present invention, shape estimate reconstructor 15 may determine a depth map D_{Q} for image I_{Q} such that every patch of mappings in M=(I,D) is found to have a matching counterpart in S.

As shown in FIG. 2, shape estimate reconstructor 15 may comprise an appearance match finder 52 and an iterator 53. Iterator 53 may comprise depth map compiler 54, mapping match finder 56 and examples updater 58. Shape estimate reconstructor 15 may first employ appearance match finder 52 to find patches in example database S which match the appearance of patches in image I_{Q}. FIG. 3 shows the two method steps, SER-1 and SER-2, performed by appearance match finder 52. First in method step SER-1, appearance match finder 52 may consider a patch centered at each pixel p in image I_{Q}. Exemplary patches Wp1 and Wp2 centered at exemplary pixels p1 and p2 respectively in image I_{Q} are shown in FIG. 2.

Then, in method step SER-2, appearance match finder 52 may seek a matching patch in database S for each patch of step SER-1. In accordance with the present invention, appearance match finder 52 may determine that a patch in database S is a match for a patch in image I_{Q}, in terms of appearance, when it detects a similar intensity pattern in the least squares sense. It will be appreciated that the present invention also includes alternative methods for detecting similar intensity patterns in patches. Exemplary matching patches MWp1 and MWp2 found by appearance match finder 52 in database S images Iₙ and Iᵢ, respectively, to match exemplary image I_{Q} patches Wp1 and Wp2, respectively, are shown in FIG. 2.

In accordance with the present invention, and as shown in FIGS. 2 and 3, the next two method steps, SER-3 and SER-4, may be performed by depth map compiler 54. In method step SER-3, depth map compiler 54 may extract the corresponding depth values for each matching patch found by appearance match finder 52. In FIG. 2, reference numerals DMWp1 and DMWp2 denote the areas of depth maps Dn and Di respectively, which contain the corresponding depth values for exemplary matching patches MWp1 and MWp2, respectively.

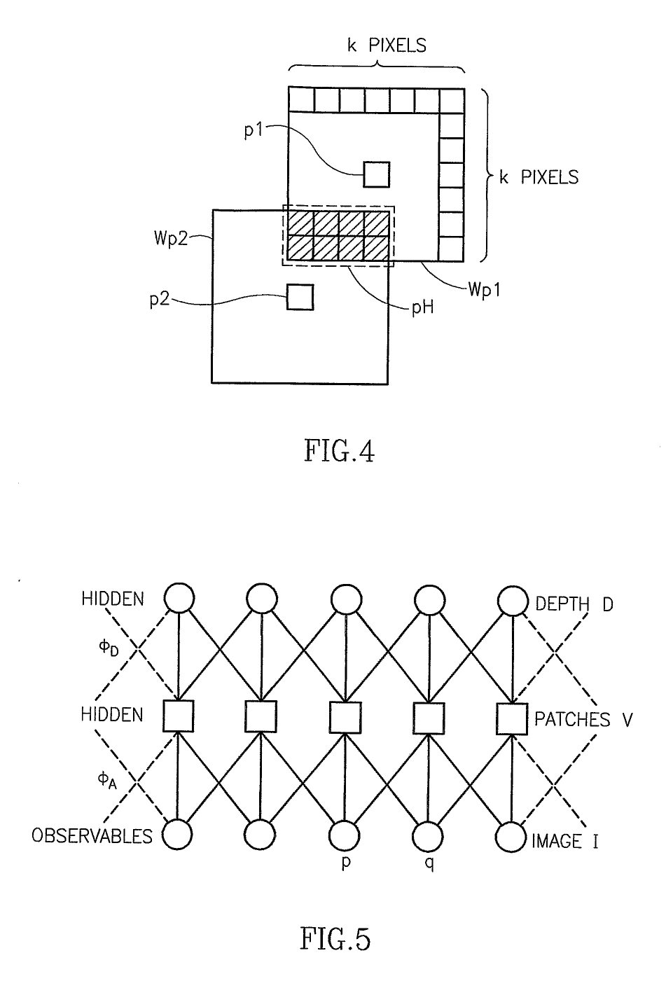

In method step SER-4, as shown in FIGS. 2 and 3, depth map compiler 54 may produce D_{Q}, a depth map for image I_{Q}, by compiling the depth values extracted in method step SER-3 for each pixel p. FIG. 4, reference to which is now made, is helpful in understanding method step SER-4. In accordance with the present invention, each image patch considered in method step SER-1, and thus each matching patch found in method step SER-2, and thus each corresponding depth map patch of method step SER-3, may be a window having a length of k pixels and a width of k pixels, as shown in FIG. 4. Thus, as many as k×k depth values may be extracted in method step SER-3 for each image patch of step SER-1, one for each pixel in the image patch window.

Furthermore, since method step SER-1 considers a distinct k×k patch centered at each pixel p in image I_{Q}, each pixel p in image I_{Q} may be contained in multiple overlapping image patches. This is illustrated in FIG. 4 where group pH of eight hatched pixels are shown to be contained both in image patch Wp1 centered at pixel p1, and image patch Wp2 centered at pixel p2. Accordingly, multiple depth values, associated with each of the overlapping image patches in which a pixel p is contained, may be associated with each pixel p in image I_{Q}.

In method step SER-4, as shown in FIGS. 2 and 3, depth map compiler 54 may therefore be employed in accordance with the present invention, to take an average of the multiple depth values from overlapping patches associated with each pixel p in image I_{Q} in order to calculate a single depth value for each pixel p in image I_{Q}. It will be appreciated that depth map compiler 54 may use other alternatives for the calculation of the depth value for each pixel p, e.g., weighted mean, median, etc. Depth map compiler 54 may thus produce D_{Q}, a depth map for image I_{Q}, once it has calculated a single depth value for each pixel p in image I_{Q}.

It will be appreciated that the size of patches in the present invention may not be limited to k×k as described herein. Rather, the patches may be of any suitable shape. For example, they may be rectangular. However, for the sake of clarity, the patches are described herein as being of size k×k.

The present invention further provides a global optimization procedure for iterative depth refinement, which is denoted as process IDR in FIG. 3, and which may be performed by iterator 53. The global optimization procedure provided by the present invention may ensure that the depth map D_{Q} produced by depth map compiler 54 may be consistent with both input image I_{Q} and depth examples Dᵢ . . . Dₙ in database S. This consistency may not otherwise be guaranteed, since, in the process described hereinabove, the depth at each pixel may be selected independently of its neighbors, and patches in M=(I,D) for depth map D_{Q} may not be consistent with patches in database S.

In accordance with the present invention, the first depth map D_{Q} produced by depth map compiler 54 subsequent to the first performance of each of method steps SER-1, SER-2, SER-3 and SER-4, may serve as an initial guess for shape estimate 25, and may subsequently be refined by iteratively repeating process IDR of FIG. 3 until convergence. As shown in FIG. 2, mapping match finder 56 may seek, for mappings M=(I,D) of depth map D_{Q}, patches in database S which provide a match both in terms of appearance and depth.

In the example shown in FIG. 2, depth map D_{Q} is the initial guess for shape estimate 25, produced by depth map compiler 54 in the first performance of method step SER-4. Window Wp1 is a k×k window around pixel p1 of image I_{Q}, and window DWp1 is the corresponding k×k window in depth map D_{Q}, providing the depth values from depth map D_{Q} for the pixels in window Wp1. In accordance with the present invention, and method step SER-5 of FIG. 3, mapping match finder 56 may search database S for a patch whose mapping M=(I,D) matches the appearance and depth DWp1 of patch Wp1. As in the case of appearance match finder 52 and method step SER-2, mapping match finder 56 may perform method step SER-5 for every pixel p in I_{Q}, such that depth map compiler 54 may extract up to k² best matching depth estimates for every pixel p in I_{Q}, and may average these estimates (or perform an alternative calculation) to calculate a single depth value for every pixel p in image I_{Q}.

It will be appreciated that each time depth map compiler 54 performs method step SER-4, it may produce a new depth map D_{Q}, which, in accordance with the present invention, may be a more refined version of the depth map D_{Q} produced in the previous iteration. In accordance with the present invention, mapping match finder 56 may produce shape estimate 25 when depth map D_{Q} converges to a final result.

In accordance with the present invention, the algorithm performed by mapping match finder 56 as described hereinabove may be given as:

D=estimateDepth(I,S)
M=(I,?)
repeat until no change in M
(i) ν=getSimilarPatches(M,S)
(ii) D=updateDepths(M,ν)
   M=(I,D)

The function getSimilarPatches may search database S for patches of mappings which match those of M, in the least squares sense, or using an alternative method of comparison. The set of all such matching patches may be denoted ν. The function updateDepths may then update the depth estimate D at every pixel p by taking the mean over all depth values for p in ν. It will be appreciated that this process is a hard-EM optimization (as in Kearns et al. An information-theoretic analysis of hard and soft assignment methods for clustering. UAI, 1997) of the global target function:

$$Plaus ( D \vert I , S ) = {\sum }_{p ∈ I} \begin{matrix}max \\ v ∈ S\end{matrix} Sim ( {W}_{p} , V )$$

Where Wp is a k×k window from the query M centered at p, containing both intensity values and (unknown) depth values, and V is a similar window in some MᵢεS. The similarity measure Sim(Wₚ,V) is:

$$Sim ( {W}_{p} , V ) = exp ( - \frac{1}{2} {( {W}_{p} - V )}^{T} {\sum }^{- 1} ( {W}_{p} - V ) )$$

where Σ is a constant diagonal matrix, its components representing individual variances of the intensity and depth components of patches for the particular class of input image I_{Q}. These may be provided by the user as weights to account for, for example, variances due to global structure of objects of a particular class. The incorporation in the present invention of assumptions regarding global structure of objects in the same class will be discussed later in further detail.

To make this norm robust to illumination changes, the intensities in each window may be normalized to have zero mean and unit variance, in a manner similar to the normalization often applied to patches in detection and recognition methods, as in Fergus et al. (A sparse object category model for efficient leaning and exhaustive recognition. CVPR, 2005).

It will be appreciated that, in accordance with the present invention, the iterative depth refinement process IDR of FIG. 3 is guaranteed to converge to a local maximum of Plaus(D|I,S). FIG. 5, reference to which is now made, shows a graphical model representation of the problem solved in the present invention, from which the target function of the present invention Plaus(D|I,S) may be derived as a likelihood function. It may further be shown that optimization process IDR is a hard-EM variant, producing the local maximum of this likelihood.

In FIG. 5, the intensities of the query image I are represented as observables and the matching database patches ν and the sought depth values D are represented as hidden variables. The joint probability of the observed and hidden variables may be formulated through the edge potentials by:

$$f ( I , v ; D ) = {\prod }_{p ∈ I} {\prod }_{q ∈ {W}_{p}} {φ}_{I} ( {V}_{p} ( q ) , I ( q ) ) \cdot {φ}_{D} ( {V}_{p} ( q ) , D ( q ) )$$

where Vₚ is the database patch matched with Wₚ by the global assignment ν. Taking φ_{I} and φ_{D} to be Gaussians with different covariances over the appearance and depth respectively, implies

$$f ( I , v ; D ) ∝ {\prod }_{p ∈ I} Sim ( {W}_{p} , {V}_{p} )$$

Integrating over all possible assignments of ν, the following likelihood function may be obtained:

$$L = f ( I ; D ) = {\sum }_{v} f ( I , v ; D ) = {\sum }_{v} {\prod }_{p ∈ I} Sim ( {W}_{p} , {V}_{p} )$$

The sum may be approximated with a maximum operator which is common practice for EM algorithms, often called hard-EM as in Kearns et al. (An information-theoretic analysis of hard and soft assignment methods for clustering. UAI, 1997). Since similarities may be computed independently, the product and maximum operators may be interchanged, obtaining the following maximum log likelihood:

$$max log L \approx {\sum }_{p ∈ I} {max}_{V ∈ S} Sim ( {W}_{p} , V ) = Plaus ( D \vert I , S )$$

which is the cost function Plaus(D|I,S).

The function estimateDepth of process IDR (FIG. 3) may maximize this measure by implementing a hard-EM optimization. The function getSimilarPatches may perform a hard E-step (of the hard-EM process) by selecting the set of assignments ν^{t+1} for time t+1 which may maximize the posterior:

$$f ( {v}^{t + 1} \vert I ; {D}^{t} ) ∝ {\prod }_{p ∈ I} Sim ( {W}_{p} , {V}_{p} )$$

where D^{t} may be the depth estimate at time t. Due to the independence of patch similarities, this may be maximized by finding for each patch in M the most similar patch in database S, in the least squares sense.

The function updateDepths may approximate the M-step (of the hard-EM process) by finding the most likely depth assignment at each pixel:

$${D}^{t + 1} ( p ) = arg {max}_{D ( p )} ( - {\sum }_{q ∈ {W}_{p}} ( D ( p ) - {depth ( {V}_{q}^{t + 1} ( p ) )}^{2} ) )$$

This may be maximized by taking the mean depth value over all k² estimates depth(V_{q}^{t+1}(p)), for all neighboring pixels q.

In accordance with the present invention, the optimization process IDR of FIG. 3 may be enhanced by the performance of multi-scale processing and approximate nearest neighbor (ANN) searching.

To perform multi-scale processing, process IDR may be performed in a multi-scale pyramid representation of M. This may both speed convergence and add global information to the process. Starting at the coarsest scale, the process may iterate until convergence of the depth component. Final coarse scale selections may then be propagated to the next, finer scale (i.e., by multiplying the coordinates of the selected patches by 2), where intensities may then be sampled from the finer scale example mappings.

It will be appreciated that the most time consuming step in the algorithm provided in the present invention is seeking a matching database window for every pixel in getSimilarPatches. In accordance with the present invention, this search may be speeded by using a sub-linear approximate nearest neighbor search as in Arya et al. (An optimal algorithm for approximate nearest neighbor searching in fixed dimensions. Journal of the ACM, 45(6), 1998.) This approach may not guarantee finding the most similar patches V, however, the optimization may be robust to these approximations, and the speedup may be substantial.

It will further be appreciated that the use of patch examples, such as in the present invention, for a variety of applications, from recognition to texture synthesis, is predicated on the assumption that class variability can be captured by a finite, often small, set of examples. This is often true, but when the class contains non-rigid objects, objects varying in texture, or when viewing conditions are allowed to change, reliance on this assumption can become a problem. Adding more example objects in database S to allow for more variability (e.g., rotations of the input image as in Drori et al. (Fragment-based image completion. In SIGGRAPH 2003)), implies larger storage requirements, longer running times, and higher risk of false matches.

The present invention provides a method for reconstructing shapes for images of non-rigid objects (e.g. hands), objects which vary in texture (e.g. fish), and objects viewed from any direction, by providing a method for updating database S on-the-fly during the reconstruction process. In this method, rather than committing to a fixed set of reference examples at the onset of reconstruction, database S may be updated during the reconstruction process to contain example objects which have the most similar shapes to that of the object in input image I_{Q} and which are viewed under the most similar conditions. As shown in FIGS. 2 and 3, examples updater 58 may update database S during reconstruction process SER in accordance with method step SER-6.

In accordance with the present invention, the reconstruction process may start with an initial seed database Ss of examples. In subsequent iterations of process IDR, the least used examples Mᵢ may be dropped from seed database Ss, and replaced with better examples. In accordance with the present invention, examples updater 58 may produce better examples by rendering more suitable 3D objects with better viewing conditions on-the-fly, during reconstruction process SER. It will be appreciated that other parameters such as lighting conditions may be similarly resolved. It will further be appreciated that this method may provide a potentially infinite example database (e.g., infinite views), where only a small relevant subset is used at any one time.

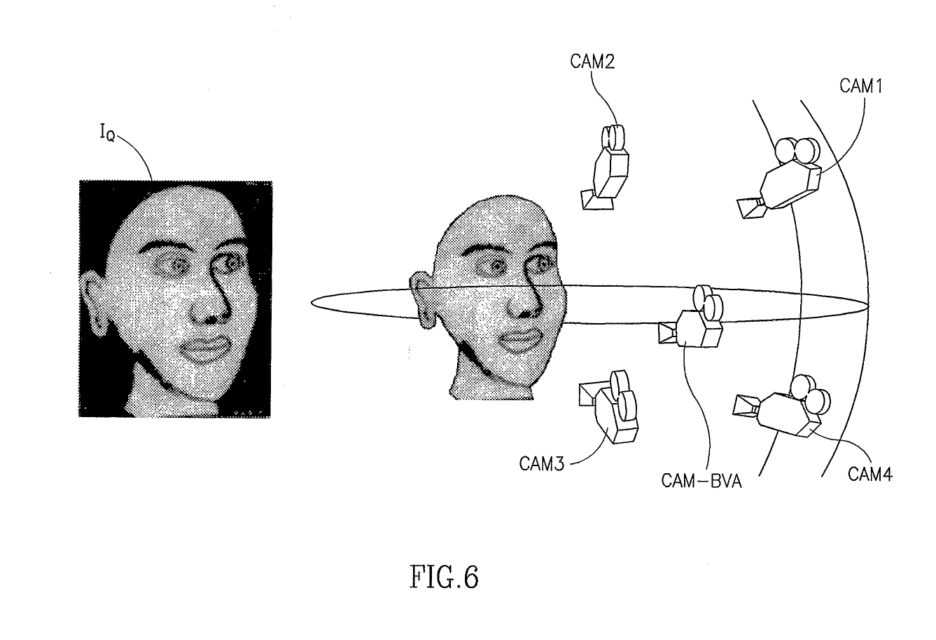

FIG. 6, reference to which is now made, illustrates the method provided by the present invention for updating database S with example objects having the most similar viewing conditions as those of the input image. Exemplary input image I_{Q} in FIG. 6 shows the face of a woman viewed from an angle.

A small number of pre-selected views, sparsely covering parts of the viewing sphere, may first be chosen. In the example shown in FIG. 6, these pre-selected views are indicated by cameras CAM1, CAM2, CAM3 and CAM4, which are trained on the woman shown in image I_{Q} from four widely spaced viewing angles. Examples updater 58 may then produce seed database Ss by taking mappings Mᵢ of database objects rendered from these views, and then depth map compiler 54 may refer to seed database Ss to obtain an initial depth estimate D_{Q}.

Since mappings from viewing angles closer to the viewing angle of input image I_{Q} may be reasonably expected to contribute more patches in the matching process of method step SER-5 (FIG. 3) than those viewing angles which are further away from the viewing angle of input image I_{Q}, in subsequent iterations of process IDR, examples updater 58 may re-estimate a better viewing angle BVA for objects in database Ss. In accordance with the present invention, better viewing angle BVA may be calculated by talking the mean of the currently used angles, weighted by the relative number of matching patches found from each angle by mapping match finder 56. Better viewing angle BVA may alternatively be calculated by other suitable methods. Examples updater 58 may then drop from Ss mappings originating from the least used angle, and replace them with ones from better viewing angle BVA. If better viewing angle BVA is sufficiently close to one of the previously used angles, examples updater 58 may instead increase the number of example objects in Ss in order to maintain its size.

An exemplary better viewing angle BVA is illustrated in FIG. 6, where the angle at which camera CAM-BVA is trained on the woman appears to approximate the angle at which the woman in input image k is viewed.

Applicants have realized that although methods exist which accurately estimate the viewing angle of an image, as in Osadchy et al. (Synergistic face detection and pose estimation with energy-based model. NIPS, 2004) and Romdhani et al. (Face identification by fitting a 3D morphable model using linear shape and texture error functions. ECCV, 2002), it may be preferable to embed this estimation in the reconstruction method, as is provided by the present invention. For example, in the case of non-rigid classes, such as the human body, posture cannot be captured with only a few parameters. When the estimation of viewing angle is embedded in the reconstruction method, such as in the present invention, information from several viewing angles may be processed simultaneously, and it may not be necessary to pre-commit to any single view.

In addition to updating the viewing angle of objects in database S, examples updater 58 may also update database S so that the example objects used for reconstruction may have the most similar shapes to that of the object in input image I_{Q}. Starting with a set of arbitrarily selected objects as seed database Ss, examples updater 58 may drop from seed database Ss, the objects least referenced by mapping match finder 56 at every iteration of process IDR Examples updater 58 may then scan the remaining database objects to determine which ones have a depth Dᵢ which best matches the current depth estimate D_{Q} (i.e., for which (D_{Q}−Dᵢ)² is smallest when D_{Q} and Dᵢ are aligned at the center), and add them to database Ss in place of the dropped objects.

It will be appreciated that examples updater 58 may thus automatically select, from a database S containing objects from many classes, objects of the same class as the object in input image I_{Q}, for reconstruction of the object in input image I_{Q} in accordance with the present invention.

The global optimization scheme described hereinabove with respect to FIGS. 2 and 3 makes an implicit stationarity assumption as in Wei et al. (Fast texture synthesis using tree-structured vector quantization. SIGGRAPH 2000). That is, the probability for the depth at any pixel, given those of its neighbors, is the same throughout the output image. It will be appreciated that this is generally untrue for structured objects, where depth often depends on position. For example, the probability of the depth of a pixel being tip-of-the-nose high is different at different locations of a face.

Consequently, the present invention provides a method for enforcing non-stationarity by adding additional constraints to the patch matching process. Specifically, the selection of patches from similar semantic parts is encouraged, by favoring patches which match not only in intensities and depth, but also in position relative to the centroid of the input depth. This is achieved by adding relative position values to each patch of mappings in both the database and input image.

In accordance with the method provided by the present invention to encourage the selection of matching patches from similar semantic parts of an image, p=(x,y) may be given as the (normalized) coordinates of a pixel in I, and (x_{c}, y_{c}) may be given as the coordinates of the center of mass of the area occupied by non background depths in the current depth estimate D. The values (δx, δy)=(x−x_{c}, y−y_{c}) may be added to each patch Wₚ and similar values may be added to all database patches (i.e., by using the center of each depth image Dᵢ for (x_{c}, y_{c})).

In accordance with the present invention, these values, acting as position preservation constraints, may force the matching process to find patches similar in both mapping and global position, such that a better result is produced for shape estimate 25.

In accordance with the present invention, if the input object is segmented from the background, an initial estimate for its centroid may be obtained from the foreground pixels. Alternatively, in this situation, position preservation constraints may be applied only after an initial depth estimate has been computed.

In accordance with the present invention, the mapping at each pixel in M and similarly every Mᵢ, may encode both appearance and depth. In practice, the appearance component of each pixel may be its intensity and high frequency values, as encoded in the Gaussian and Laplacian pyramids of I as in Burt et al. (The laplacian pyramid as a compact image code. IEEE Trans, on Communication, 1983.) Applicants have realized that direct synthesis of depths may result in low frequency noise (e.g., “lumpy” surfaces). Therefore, in accordance with the present invention, a Laplacian pyramid of depth may rather be estimated, producing a final depth by collapsing the depth estimates from all scales. In this fashion, low frequency depths may be synthesized in the coarse scale of the pyramid and only sharpened at finer scales.

It will further be appreciated that different patch components, including relative positions, may contribute different amounts of information in different classes, as reflected by their different variance. For example, faces are highly structured, thus, position plays an important role in their reconstruction. On the other hand, due to the variability of human postures, relative position is less reliable for the class of human figures.

Therefore, in accordance with the present invention, different components of each Wp may be amplified for different classes by weighting them differently. Four weights, one for each of the two appearance components, one for depth, and one for relative position may be used. These weights may be set once for each object class, and changed only when the input image is significantly different from the images in database S.

In accordance with the present invention, shape reconstructor 10 may perform additional steps to refine shape estimate 25 and ultimately produce shape reconstruction 35. Shape reconstructor 10 may first employ colorizer 17 to apply color to shape estimate 25, which may produce colorized model 27. Then, shape reconstructor 10 may employ refined shape reconstructor 19 to produce shape reconstruction 35. Refined shape reconstructor 19 may perform example-based reconstruction using a single example object, which may be colorized model 27. Refined shape reconstructor 19 may produce shape reconstruction 35 by using input image I_{Q} as a guide to mold colorized model 27. Specifically, refined shape reconstructor 19 may modify the shape and albedo of colorized model 27 to fit image I_{Q}.

The detailed operation of colorizer 17 is described with respect to FIGS. 7 and 8, reference to which is now made. FIG. 7 illustrates the operation of colorizer 17. FIG. 8 is a flow chart illustrating the method steps of process COL performed by colorizer 17, in accordance with the present invention, to construct colorized model 27 for shape estimate 25.

In accordance with the present invention, colorizer 17 may produce an image-map I_{Q} for a query shape S_{Q} having depth D_{Q} by using examples of feasible mappings from depths to intensities for similar objects whose intensities I are known. The process performed by colorizer 17 to determine unknown intensities when depth values are known (for a shape), may be largely analogous to the process performed by shape estimate reconstructor 15 as described with respect to FIGS. 2 and 3, for determining unknown depth values when intensities are known (for an image).

In the case of shape estimate reconstructor 15, as described previously with respect to FIG. 2, database S may contain mappings of intensities to depths, i.e., S={Mᵢ}ᵢ₌₁ⁿ={(Dᵢ, Iᵢ)}ᵢ₌₁ⁿ, where Iᵢ and Dᵢ are the image and the depth map, respectively, of an object from the same class as the object shown in image I_{Q}. In the case of colorizer 17, database S may contain mappings of depths to intensities, i.e., S={Mᵢ}ᵢ₌₁ⁿ={(Iᵢ, Dᵢ)}ᵢ₌₁ⁿ, where Dᵢ and Iᵢ are the depth and image map, respectively, of an object from the same class as the input shape.

While shape estimate reconstructor 15 may, in accordance with the present invention, determine a depth map D_{Q} for image I_{Q} such that every patch of mappings in M=(I,D) is found to have a matching counterpart in S, colorizer 17 may determine an image-map I_{Q} for a depth map D_{Q} such that every patch of mappings in M=(D,I) is found to have a matching counterpart in S. In accordance with the present invention, image map I_{Q} must fulfill a second criterion, i.e., database patches matched with overlapping patches in M will agree on the colors I(p) at overlapped pixels p=(x,y).

As shown in FIG. 7, colorizer 17 may comprise a depth match finder 82 and an iterator 83. Iterator 83 may comprise intensity compiler 84 and mapping match finder 86. It may be seen in a comparison of FIGS. 2 and 7 that the depth match finder 82, iterator 83, intensity compiler 84 and mapping match finder 86 components of colorizer 17 correspond to the appearance match finder 52, iterator 53, depth map compiler 54 and mapping match finder 56 components of shape estimate reconstructor 15. However, colorizer 17 may not include a component corresponding to examples updater 58 of shape estimate reconstructor 15.

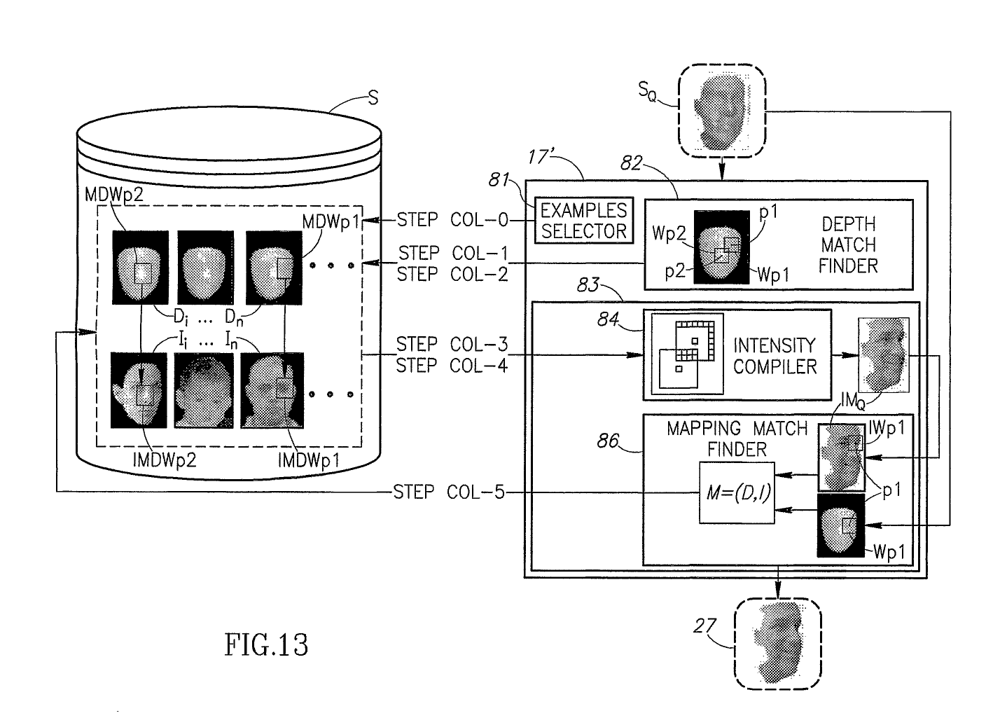

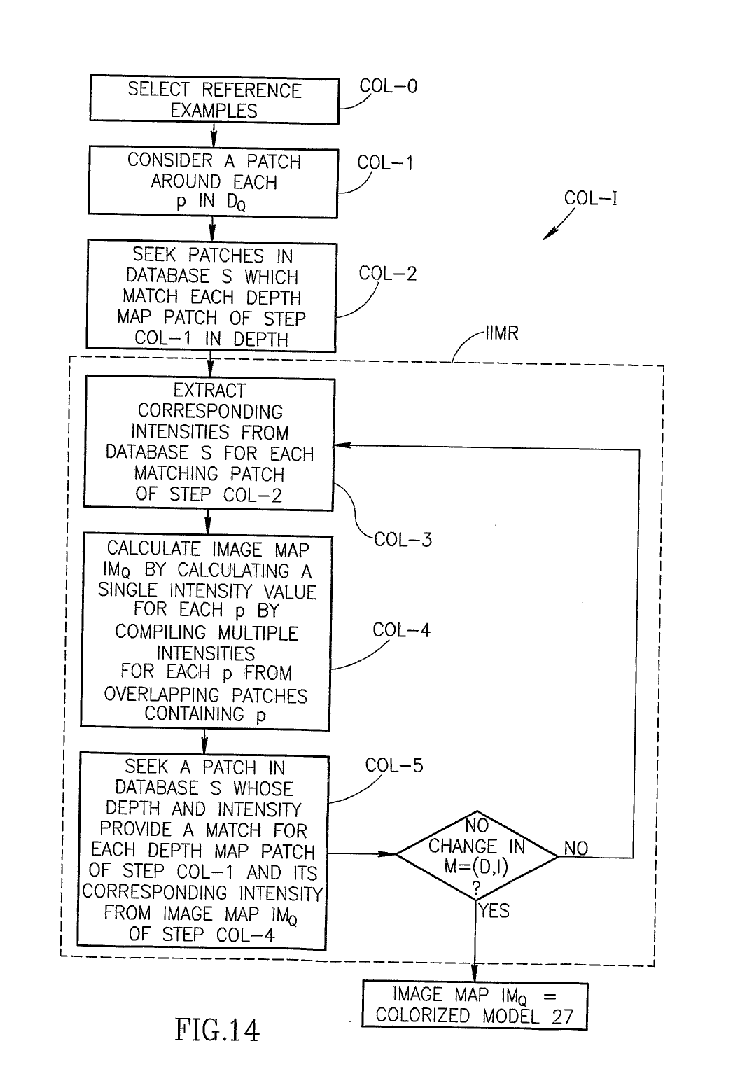

In the process shown in FIG. 1, colorizer 17 may perform colorization process COL on shape estimate 25, the output of shape estimate reconstructor 15, and the example objects used in process COL may be the final database example objects chosen by examples updater 58 in process SER. In this configuration, colorizer 17 may not choose example objects. In an alternative embodiment of the present invention, which will be discussed later with respect to FIGS. 13 and 14, colorizer 17 may operate independently, rather than as a component of shape reconstructor 10. Operating independently, colorizer 17 may also include a component for choosing example objects from database S.

Colorizer 17 may first employ depth match finder 82 to find patches in example database S which match the depths of patches in depth map D_{Q} of shape estimate 25. FIG. 8 shows the two method steps, COL-1 and COL-2, performed by depth match finder 82. First, in method step COL-1, depth match finder 82 may consider a patch centered at each pixel p in depth-map D_{Q}. Exemplary patches Vp1 and Wp2 centered at exemplary pixels p1 and p2 respectively in depth map D_{Q} are shown in FIG. 7.

Then, in method step COL-2, depth match finder 82 may seek a matching patch in database S for each patch of step COL-1. In accordance with the present invention, depth match finder 82 may determine that a patch in database S is a match for a patch in depth map D_{Q}, when it detects a similar depth pattern in the least squares sense. It will be appreciated that the present invention also includes alternative methods for detecting similar depth patterns in patches. Exemplary matching patches MDWp1 and MDWp2 found by depth match finder 82 in database S depth maps Dₙ and Dᵢ, respectively, to match exemplary depth map D_{Q} patches Wp1 and Wp2, respectively, are shown in FIG. 7.

In accordance with the present invention, and as shown in FIGS. 7 and 8, the next two method steps, COL-3 and COL-4, may be performed by intensity compiler 84. In method step COL-3, intensity compiler 84 may extract the corresponding intensity values for each matching patch found by depth match finder 82. In FIG. 7, reference numerals IMDWp1 and IMDWp2 denote the areas of images In and Ii respectively, which contain the corresponding intensities for exemplary matching patches MDWp1 and MDWp2, respectively.

In method step COL-4, as shown in FIGS. 7 and 8, intensity compiler 84 may produce IM_{Q}, an image map for depth map D_{Q}, by compiling the intensities extracted in method step COL-3 for each pixel p. As explained previously with respect to FIG. 4, each depth map patch considered in method step COL-1, and thus each matching patch found in method step COL-2, and thus each corresponding image patch of method step COL-3, may be a window having a length of k pixels and a width of k pixels, as shown in FIG. 4. Thus, as many as k×k intensity values may be extracted in method step COL-3 for each depth map patch of step COL-1, one for each pixel in the depth map patch window.

Furthermore, since method step COL-1 considers a distinct k×k patch centered at each pixel p in depth map D_{Q}, each pixel p in depth map D_{Q} may be contained in multiple overlapping depth map patches, as explained previously with respect to FIG. 4. Accordingly, multiple intensity values, associated with each of the overlapping depth map patches in which a pixel p is contained, may be associated with each pixel p in depth map D_{Q}.

In method step COL-4, as shown in FIGS. 7 and 8, intensity compiler 84 may therefore be employed in accordance with the present invention, to take an average of the multiple intensity values from overlapping patches associated with each pixel p in depth map D_{Q}. It will be appreciated that intensity compiler 84 may use other alternatives for the calculation of the intensity at each pixel p, e.g., weighted mean, median, etc. Intensity compiler 84 may thus produce IM_{Q}, once it has calculated a single intensity value for each pixel in depth map D_{Q}.

The present invention further provides a global optimization procedure for iterative image map refinement, which is denoted as process IIMR in FIG. 8, which may be performed by iterator 83, and which may correspond to process IDR of FIG. 3. The global optimization procedure provided by the present invention may ensure that the image map I_{Q} produced by intensity compiler 84 may be consistent with both input depth D_{Q} and image examples Iᵢ . . . Iₙ in database S. This consistency may not otherwise be guaranteed, since, in the process described hereinabove, the depth at each pixel may be selected independently of its neighbors, and patches in M=(D,I) for image map IM_{Q} may not be consistent with patches in database S.

In accordance with the present invention, the first image map IM_{Q} produced by intensity compiler 84 subsequent to the first performance of each of method steps COL-1, COL-2, COL-3 and COL-4, may serve as an initial guess for colorized model 27, and may subsequently be refined by iteratively repeating process IIMR of FIG. 8 until convergence. As shown in FIG. 7, mapping match finder 86 may seek, for mappings M=(D,I) of image map IM_{Q}, patches in database S which provide a match both in terms of depth and intensity.

In the example shown in FIG. 7, image map IM_{Q} is the initial guess for colorized model 27, produced by intensity compiler 84 in the first performance of method step COL-4. Window Wp1 is a k×k window around pixel p1 of depth map D_{Q}, and window IWp1 is the corresponding k×k window in image map IM_{Q}, providing the intensities from image map IM_{Q} for the pixels in window Wp1. In accordance with the present invention, and method step COL-5 of FIG. 8, mapping match finder 86 may search database S for a patch whose mapping M=(D,I) matches the depth and intensity IWp1 of patch Wp1. As in the case of depth match finder 82 and method step COL-2, mapping match finder 86 may perform method step COL-5 for every pixel p in D_{Q}, such that intensity compiler 84 may extract up to k² best matching intensities for every pixel p in D_{Q}, and may average these estimates (or perform an alternative calculation) to calculate a single intensity for every pixel p in depth map D_{Q}.

It will be appreciated that each time intensity compiler 84 performs method step COL-4, it may produce a new image map IM_{Q}, which, in accordance with the present invention, may be a more refined version of the image map IM_{Q} produced in the previous iteration. In accordance with the present invention, mapping match finder 86 may produce colorized model 27 rather than proceed with the search process of method step COL-5 when image map IM_{Q} converges to a final result.

Process IIMR of FIG. 8, like its counterpart, process IDR of FIG. 3, optimizes the following global target function:

$$Plaus ( I \vert D , S ) = {\sum }_{p ∈ M} {max}_{v ∈ S} Sim ( {W}_{p} , V )$$

where the knowns and unknowns in the two processes (intensities and depths respectively, in process IDR, and depths and intensities respectively, in process IIMR) are reversed. The global target function, in turn, satisfies the criteria for image map IM_{Q}. Wp may denote a k×k window from the query M centered at p, containing both depth values and (unknown) intensities, and V may denote a similar window in some MᵢεS. The similarity measure Sim(Wₚ,V) is:

$$Sim ( {W}_{p} , V ) = exp ( - \frac{1}{2} {( {W}_{p} - V )}^{T} {Σ}^{- 1} ( {W}_{p} - V ) )$$

where Σ is a constant diagonal matrix, its components representing individual variances of the intensity and depth components of patches. These may be provided by the user as weights to account for, for example, variances due to global structure of objects of a particular class, as explained hereinabove.

Process IIMR, like process IDR, as described hereinabove, can be considered a hard-EM process as in Kearns et al., and thus may be guaranteed to converge to a local maximum of the target function.

The global optimization scheme of process IIMR also makes an implicit stationarity assumption, similar to the implicit stationarity assumption of the global optimization scheme of process IDR. That is, the probability for the color at any pixel, given those of its neighbors, is the same throughout the output image. It will be appreciated that this may be true for textures, but it is generally untrue for structured images, where pixel colors often depend on position. For example, the probability of the color of a pixel being lipstick red is different at different locations of a face.

This problem has been overcome, as in Zhou et al. (Texturemontage: Seamless texturing of arbitrary surfaces from multiple images SIGGRAPH 2005) by requiring the modeler to explicitly form correspondences between regions of the 3D shape and different texture samples. The present invention may provide a solution to this problem which does not require user intervention by enforcing non-stationarity through the addition of constraints to the patch matching process. Specifically, the selection of patches from similar semantic parts may be encouraged, by favoring patches which match not only in depth and color, but also in position relative to the centroid of the input depth. This may be achieved by adding relative position values to each patch of mappings in both the database and input depth map.

In accordance with the method provided by the present invention to encourage the selection of matching patches from similar semantic parts of an image, p=(x,y) may be given as the (normalized) coordinates of a pixel in M, and (x_{c}, y_{c}) may be given as the coordinates of the centroid of the area occupied by non background depths in D. The values (δx, δy)=(x−x_{c},y−y_{c}) may be added to each patch Wₚ and similar values may be added to all database patches (i.e., by using the center of each depth image Dᵢ for (x_{c}, y_{c})). These values, acting as position preservation constraints, may force the matching process to find patches similar in both mapping and global position, such that a better result is produced for colorized model 27.

In accordance with the present invention, the optimization process IIMR of FIG. 8 may be enhanced by the performance of multi-scale processing and approximate nearest neighbor (ANN) searching in a manner similar to the implementation of these enhancements in process IDR of FIG. 3 as described previously hereinabove.

The optimization provided by multi-scale processing may be performed in a multi-scale pyramid of M, using similar pyramids for each Mi. This may both speed convergence and add global information to the process. Starting at the coarsest scale, the process may iterate until intensities converge. Final coarse scale selections may then be propagated to the next, finer scale (i.e., by multiplying the coordinates of the selected patches by 2), where intensities may then be sampled from the finer scale example mappings. Upscale may thus be performed by interpolating selection coordinates, not intensities, so that fine scale high frequencies may be better preserved.

The search for matching patches may further be speeded by using a sub-linear ANN search as in Arya et al. This may not guarantee finding the most similar patches, but the optimization may be robust to these approximations, and the speedup may be substantial.

In accordance with the present invention, the optimization process IIMR of FIG. 8 may further be enhanced through the use of PCA principle component analysis) patches. That is, before the first matching process of each scale may commence, separate PCA transformations matrices may be learned from the depth and intensity bands of the example objects used for image-map synthesis. For example, a fifth of the basis vectors with the highest variance may be kept. The matching process may thus find the most similar PCA reduced patches in the database. A speedup factor of approximately 5 may thus be provided. While some information may be lost, result quality may not be adversely affected.

In accordance with the present invention, the depth component of each Mᵢ and similarly M may be taken to be the depth itself and its high frequency values as encoded in the Gaussian and Laplacian pyramids of D. Three Laplacian pyramids, one for each of the bands in the Y—Cb—Cr color space of the image-map, may be synthesized. The final result may be produced by collapsing these pyramids. Consequently, a low frequency image-map may be synthesized at the coarse scale of the pyramid and only refined and sharpened at finer scales.

It will further be appreciated that different patch components may contribute different amounts of information in different classes, as reflected by their different variance. Therefore, the present invention may provide a method for the modeler to amplify different components of each Wp by weighting them differently. Six weights, one for each of the two depth components, three for the Y, Cb, and Cr bands, and one for relative position may be used. These weights may be selected manually, but once set for each object class, may not need to be changed.

The detailed operation of refined shape reconstructor 19 is described with respect to FIGS. 9 and 10, reference to which is now made. FIG. 9 is a block diagram showing the components of refined shape reconstructor 19. FIG. 10 is a flow chart showing the method steps of process RSR performed by refined shape reconstructor 19 in accordance with the present invention. In process RSR, refined shape reconstructor 19 may generate shape reconstruction 35 by using input image I_{Q} as a guide to mold colorized model 27. Specifically, refined shape reconstructor 19 may modify the shape and albedo of colorized model 27 to fit image I_{Q}.

As shown in FIG. 9, refined shape reconstructor 19 may comprise a lighting recoverer 102, a depth recoverer 104, and an albedo estimator 106. In accordance with the present invention, these components may be employed to reconstruct the surface of the object shown in image I_{Q} by solving the optimization function provided in the present invention for lighting, depth and albedo respectively.

The optimization function provided in the present invention is:

$${min}_{l , ρ , z} \int {\int }_{Ω} {( E - {ρ1}^{T} Y ( n ) )}^{2} + {λ}_{1} Δ g ( {d}_{z} ) + {λ}_{2} Δ g ( {d}_{ρ} ) d x d y$$

Δg(.) denotes the Laplacian of a Gaussian function, and λ₁ and λ₂ are positive constants. The first term in the optimization function, (E−ρl^{T}Y(n))², is the data term, and the other two terms, λ₁Δg(d_{z}) and λ₂Δg(d_{ρ}), are the regularization terms.

The optimization function provided in the present invention is based on the consideration of an image E(x,y) of a face, for example, which may be defined on a compact domain Ω⊂ [symbol] , whose corresponding surface may be given by z(x,y). The surface normal at every point may be denoted n(x,y) where:

$$n ( x , y ) = \frac{1}{\sqrt{{p}^{2} + {q}^{2} + 1}} {( p , q , - 1 )}^{T}$$

where p(x,y)=∂z/∂x and q(x,y)=∂z/∂y. In accordance with the present invention, it may be assumed that the image is Lambertian with albedo ρ(x,y) and the effect of cast shadows and interreflections may be ignored Under these assumptions, for an object illuminated by an arbitrary configuration of light sources at infinity, it has been shown in Basri et al. (Lambertian reflectance and linear subspaces. PAMI 25, 2003, 218-233) and Ramamoorthi et al. (On the relationship between radiance and irradiance: Determining the illumination from images of a convex lambertian object. JOSA 18, 2001, 2448-2459) that reflectance can be expressed in terms of spherical harmonics as:

$$R ( n ; ρ , 1 ) \approx ρ {\sum }_{i = 0}^{K - 1} {l}_{i} {Y}_{i} ( n )$$

where l=, (l₀, . . . l_{K-1}) denotes the harmonic coefficients of lighting and Yᵢ(n)(0≦i<K−1) includes the spherical harmonic functions evaluated at the surface normal. Because the reflectance of Lambertian objects under arbitrary lighting is very smooth, this approximation may already be highly accurate when a low order harmonic approximation is used. Specifically, a second order harmonic approximation (including nine harmonic functions) may capture on average at least 99.2% of the energy in an image. A first order approximation (including four harmonic functions) may also be used with somewhat less accuracy. It has been shown analytically in Frolova et al. (Accuracy of spherical harmonic approximations for images of lambertian objects under far and near lighting. Proceedings of the ECCV, 2004, 574-587) that a first order harmonic approximation may capture at least 87.5% of the energy in an image, while in practice, owing to the fact that only normals with n_{z}≧0 may be observed, the accuracy may approach 95%.

Applicants have realized that reflectance may be modeled using a first order harmonic approximation, written in vector notation as:

R(n;ρ,l)≈ρl^{T}Y(n)

where Y(n)=(1,nₓ,n_{y},n_{z})^{T} and nₓ, n_{y}, n_{z} are the components of n. (It will be appreciated that formally, Y should be set to equal (1/\sqrt{4π}, \sqrt{3/(4π)}nₓ), \sqrt{3/(4π)}n_{y}), \sqrt{3/(4π)}n_{z}). However, these constant factors are omitted for convenience and the lighting coefficients are rescaled to include these factors.) The image irradiance equation may then be given by:

E(x,y)=R(n;ρ,l)

In general, when ρ and l and boundary conditions are provided, this equation may be solved using shape from shading algorithms as in Hom et al. (Shape from Shading. MIT Press: Cambridge, Mass., 1989), Rouy et al. (A viscosity solutions approach to shape-from-shading. SIAM Journal of Numerical Analysis. 29(3), 1992, 867-884), Dupuis et al. (An optimal control formulation and related numerical methods for a problem in shape reconstruction. The Annals of Applied Probability 4(2), 1994, 287-346) and Kimmel et al. (Optimal algorithm for shape from shading and path planning. Journal of Mathematical Imaging and Vision 14(3), 2001, 237-244). Therefore, the present invention may provide a method to estimate ρ and l and boundary conditions.

In accordance with the present invention, the missing information may be obtained using a single reference model, which, as explained previously with respect to FIG. 1, may be colorized model 27. The surface of the reference model may be denoted by z_{ref}(x,y), the normal to the surface may be denoted by n_{ref}(x,y), and its albedo may be denoted ρ_{ref}(x,y). This information may be used to determine lighting and to provide an initial guess for the sought albedo.

To regularize the problem, the difference shape may be defined as:

d_{z}(x,y)=z(x,y)=z_{ref}(x,y),

and the difference albedo may be defined as:

d_{ρ}(x,y)=ρ(x,y)=ρ_{ref}(x,y)

and these differences may be required to be smooth.

It will be appreciated that without regularization, the optimization function provided in the present invention is ill-posed. Specifically, for every choice of depth z(x,y) and lighting l it is possible to prescribe albedo ρ(x,y) to make the first term of the optimization function vanish. With regularization and appropriate boundary conditions, the problem becomes well-posed.

In accordance with the present invention, the optimization may be approached by solving for lighting, depth, and albedo separately. Lighting recoverer 102 (FIG. 9) may be employed first by refined shape reconstructor 19 to solve for lighting in accordance with method step RSR-1 of process RSR (FIG. 10). Lighting recoverer 102 may recover the lighting coefficients l by finding the best coefficients that fit the reference model (i.e., colorized model 27) to input image I_{Q}. This may be analogous to solving for pose by matching the features of a model face to the features extracted from an image of a different face.

In the next step of process RSR, method step RSR-2 (FIG. 10), depth recoverer 104 (FIG. 9) may solve for depth z(x,y) by using the lighting coefficients recovered by lighting recoverer 102 and the albedo of colorized model 27. This step may be analogous to the usual shape from shading problem. However, in the present invention, the boundary conditions may be incorporated in the equations as described hereinbelow.

Then, in method step RSR-3 (FIG. 10), albedo estimator 106 (FIG. 9) may use the lighting and the recovered depth of method steps RSR-1 and RSR-2 respectively, to estimate the albedo ρ(x,y). Applicants have realized that only one iteration of process RSR may be sufficient to produce a reasonable refined shape estimate 35, however, in an additional preferred embodiment of the present invention, process RSR may be repeated iteratively.

Applicants have further realized that the use of the albedo of colorized model 27 may seem restrictive since different people may vary significantly in skin color. However, linearly transforming the albedo (i.e., αρ(x,y)+β, with scalar constants α and β) can be compensated for by appropriately scaling the light intensity and changing the ambient term I₀. Therefore, the albedo recovery of the present invention may be subject to this ambiguity. Furthermore, so that the reconstruction is not influenced by marks appearing on the reference model, the albedo of the reference model may first be smoothed by a Gaussian.

In order to perform method step RSR-1, lighting recoverer 102 may substitute ρ→ρp_{ref} and z→z_{ref} (and consequently n→n_{ref}) in the optimization function provided in the present invention. Both regularization terms λ₁Δg(d_{z}) and λ₂Δg(d_{ρ}) may then vanish, leaving only the data term:

$${min}_{1} \int {\int }_{Ω} {( E - {ρ}_{ref} {1}^{T} Y ( {n}_{ref} ) )}^{2} d x d y$$

Substituting for Y and discretizing the integral yields:

$${min}_{1} {\sum }_{( x , y ) ∈ Ω} {( E ( x , y ) - {ρ}_{ref} ( x , y ) ( {l}_{0} + {\tilde{1}}^{T} {n}_{ref} ( x , y ) ) )}^{2}$$

where \ddot{l}=(l₁,l₂,l₃)^{T}. This is a highly over-constrained linear least square optimization with only four unknowns (the components of l) and may be solved by finding its pseudo-inverse, a standard matrix operation.

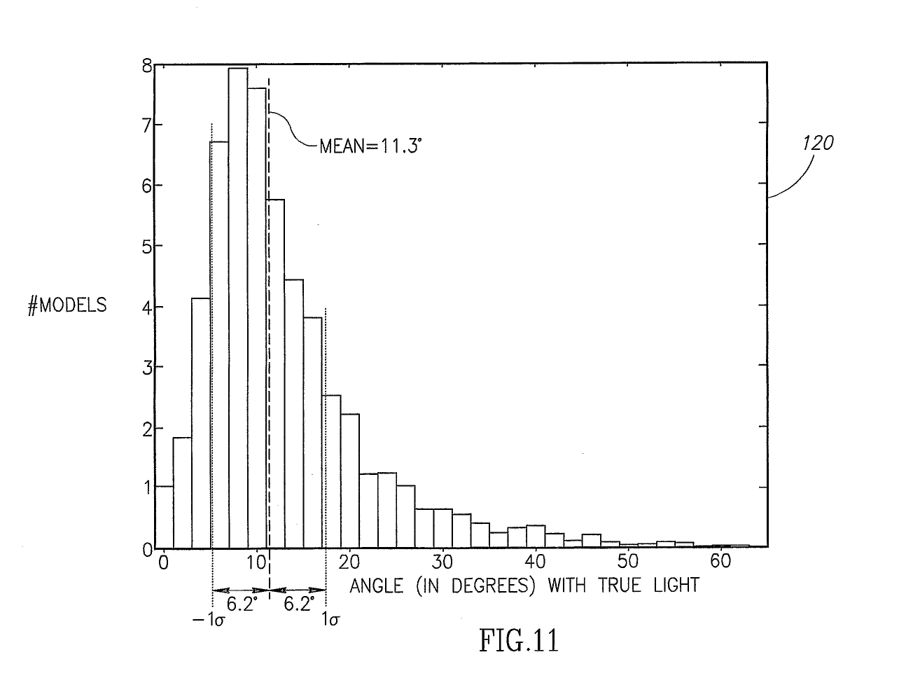

The lighting coefficients which may be recovered in method step RSR-1 as described hereinabove, may be used subsequently in method step RSR-2 to recover depth. FIG. 11, reference to which is now made, illustrates that the lighting coefficients which may be recovered for an image using method step RSR-1 as provided in the present invention may indeed be close to the true lighting coefficients for that image.

FIG. 11 shows histogram 120 of the angle (in degrees) between the true lighting coefficients and the recovered lighting coefficients for 56 images of faces, where reference models of different people were used in the lighting recovery process for each image. The angle between the true lighting and the recovered lighting, shown on the x axis of graph 120, represents the error in the lighting recovery process. The value on the y axis of graph 120 indicates the number of images for which, during the recovery process, the degree of error indicated on the x axis occurred.

As shown in FIG. 11, the mean angle for histogram 120 is 11.3°, with a standard deviation of 6.2°. Applicants have determined that this error rate may be sufficiently small, allowing accurate reconstructions.

In accordance with the present invention, once lighting recoverer 102 produces an estimate for l, depth recoverer 104 may utilize it, and continue to use ρ_{ref} for the albedo in order to recover z(x,y). Depth recoverer 104 may recover z by solving a shape from shading problem, since the reflectance function is completely determined by the lighting coefficients and the albedo. The resemblance of the sought surface to the reference model may be further exploited in order to linearize the problem.

Depth recoverer 104 may first handle the data term. Then, \sqrt{p²+q²+1} may be denoted N(x,y), and it may be assumed that N(x,y)≈N_{ref}(x,y). The data term in fact minimizes the difference between the two sides of the following equation system:

$$E = {ρ}_{ref} ( {l}_{0} + \frac{1}{{N}_{ref}} {\tilde{1}}^{T} {( p , q , - 1 )}^{T} )$$

with p and q as unknowns. With additional manipulation this becomes:

$$E - {ρ}_{ref} ( {l}_{0} + \frac{1}{{N}_{ref}} {l}_{3} ) = \frac{{ρ}_{ref}}{{N}_{ref}} ( {l}_{1} p + {l}_{2} q )$$

In discretizing this equation system, z(x,y) may be used as the unknown is, and p and q may be replaced by the forward differences:

p=z(x+1,y)−z(x,y)

q=z(x,y+1)−z(x,y)

obtaining

$$E - {ρ}_{ref} ( {l}_{0} + \frac{1}{{N}_{ref}} {l}_{3} ) = \frac{{ρ}_{ref}}{{N}_{ref}} ( \begin{matrix}{l}_{1} ( z ( x + 1 , y ) - z ( x , y ) ) + \\ {l}_{2} ( z ( x , y + 1 ) - z ( x , y ) )\end{matrix} ) .$$

The data term may thus provide one equation for every unknown. It will be appreciated that by solving for z(x,y) integrality is enforced.

Depth recoverer 104 may then handle the regularization term μ₁Δg(d_{z}). (The second, regularization term, λ₂Δg(d_{ρ}) vanishes at this stage). In accordance with the present invention, depth recoverer 104 may implement this term as the difference between d_{z}(x,y) and the average of d_{z} around (x, y) obtained by applying a Gaussian function to d_{z} (denoted g(d_{z})). Consequently, this term minimizes the difference between the two sides of the following equation system:

λ₁(z(x,y)−g(z))=λ₁(z_{ref}(x,y)−g(z_{ref}))

It will be appreciated that in order to avoid degeneracies, the input face must be lit by non-ambient light, since under ambient light intensities may be independent of surface orientation. The assumption N(x,y)≈N_{ref}(x,y) further requires that there will be light coming from directions other than the direction of the camera. If a face is lit from the camera direction (e.g., flash photography) then l₁=l₂=0 and the right-hand side of the equation

$$E - {ρ}_{ref} ( {l}_{0} + \frac{1}{{N}_{ref}} {l}_{3} ) = \frac{{ρ}_{ref}}{{N}_{ref}} ( {l}_{1} p + {l}_{2} q )$$

vanishes. This degeneracy may be addressed by solving a usual nonlinear shape from shading algorithm as in Rouy et al., Dupuis et al. and Kimmel et al.

Combining these two sets of equations, a linear set of equations may be obtained, with two linear equations for every unknown. This system of equations is still rank deficient, and boundary conditions may need to be added. Dirichlet boundary conditions may be used, but these will require knowledge of the depth values along the boundary of the face. The depth values of the reference model could be used, but these may be incompatible with the sought solution. Alternatively, the derivatives of z may be constrained along the boundaries using Neumann boundary conditions. One possibility is to assign p and q along the boundaries to match the corresponding derivatives of the reference model p_{ref} and q_{ref} so that the surface orientation of the reconstructed face along the boundaries will coincide with the surface orientation of the reference face. A less restrictive assumption is to assume that the surface is planar along the boundaries, i.e., that the partial derivatives of p and q in the direction orthogonal to the boundary ∂Ω vanish. (Note that this does not imply that the entire boundaries are planar.) This assumption will be roughly satisfied if the boundaries are placed in slowly changing parts of the face. It will not be satisfied for example when the boundaries are placed along the eyebrows, where the surface orientation changes rapidly.

It will be appreciated that in the present invention, the boundary conditions may be incorporated in the equations, as described hereinabove, and shape from shading may thus be solved for any unknown image. The present invention may thus provide a more robust method for solving shape from shading than the prior art, which can only process a known image for which some boundary conditions (depth values at the boundaries and other extremum points) are defined.

Finally, since all the equations used for the data term, the regularization term, and the boundary conditions involve only partial derivatives of z, while z itself is absent from these equations, the solution may be obtained only up to an additive factor. This may be rectified by arbitrarily setting one point to z(x₀,y₀)=z₀.

Once lighting recoverer 102 has recovered the lighting in accordance with method step RSR-1, and depth recoverer 104 has recovered the depths in accordance with method step RSR-2, albedo estimator 106 may estimate the albedo. Using the data term, the albedo is given by

$$ρ ( x , y ) = \frac{E ( x , y )}{{l}_{0} + {\tilde{1}}^{T} n ( x , y )}$$

The first regularization term is independent of ρ, and so it can be ignored, and the second term optimizes the following equations:

λ₂Δg(ρ)=λ₂Δg(ρ_{ref})

Again these provide a linear set of equations, in which the first set determines the albedo values, and the second set smoothes these values. Boundary conditions may be placed by simply terminating the smoothing process at the boundaries.

Once albedo estimator 106 has determined the albedo, refined shape reconstructor 19 may produce shape reconstruction 35.

It will be appreciated that, as shown in FIG. 1, shape estimate reconstructor 15, colorizer 17 and refined shape reconstructor 19 may work together as components of shape reconstructor 10 to reconstruct the shape of an object appearing in a query image I_{Q} using a database S containing objects and their colors. However, in accordance with an additional preferred embodiment of the present invention, components 15, 17 and 19 may operate independently. Shape estimate reconstructor 15 may produce, using a database S, a shape reconstruction for any object appearing in a query image. Colorizer 17 may colorize any shape using a database S. Finally, refined shape reconstructor 19 may, using a single reference model, reconstruct the shape of a face appearing in a query image.

In addition to reconstructing the shape of an object which appears in a query image, as discussed hereinabove, shape estimate reconstructor 15 may also be employed to reconstruct the shape of the occluded backside of an object, i.e., the part of the object which does not appear in the query image. This may be achieved by simply replacing mappings database M=(I,D) with a database containing mappings from front depth to a second depth layer, in this case the depth at the back. After employing shape estimate reconstructor 15 to recover the visible depth of an object (its depth map, D), the mapping from visible to occluded depth may be defined as M′(p)=(D(p),D′(p)), where D′ is a second depth layer. An example database of such mappings may be produced by taking the second depth layer of our 3D objects, thus getting S′=(M′ᵢ)ᵢ₌₁ⁿ. Synthesizing D′ may then proceed similarly to the synthesis of the visible depth layers, and the occluded backside of the object may thus be produced.

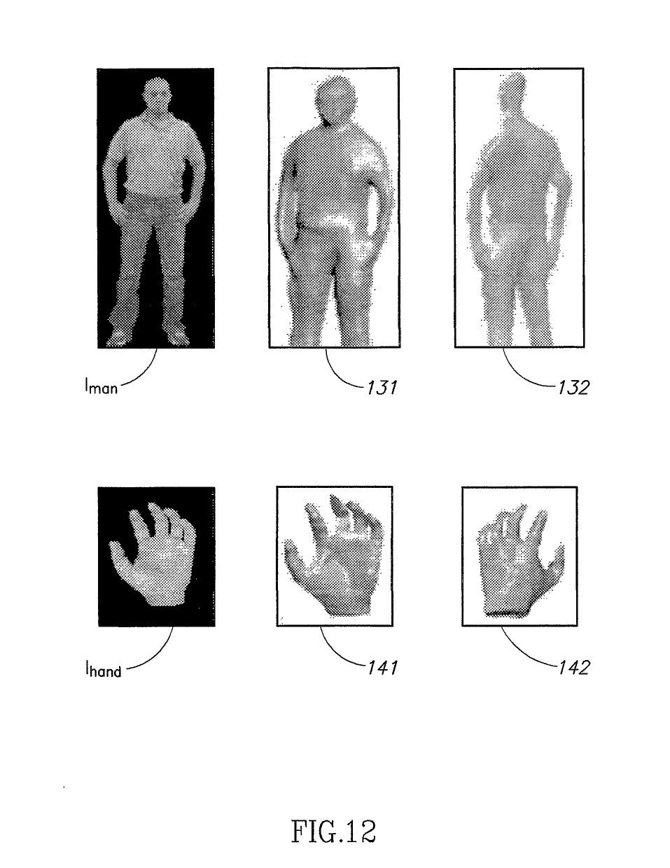

FIG. 12, reference to which is now made, shows exemplary results for reconstruction by shape estimate reconstructor 15 of a full body, shown in input image Iₘₐₙ, and a hand, shown in input image I_{hand}. For input image Iₘₐₙ, output front depth 131 and output backside depth 132 are shown. For input image I_{hand}, output front depth 141 and output backside depth 142 are show.

In an additional preferred embodiment of the present invention, colorizer 17 may operate as an independent apparatus, rather than as a component of shape reconstructor 10. In an independent capacity, colorizer 17 may be used to colorize any input shape and produce a colorized model 27. Such colorization may be used for realistic 3D renderings, such as in the animated films industry.

In an independent capacity, colorizer 17 may operate in a manner similar to that described hereinabove with respect to FIGS. 7 and 8, with the addition of a component and a method step for selecting reference examples for the colorization process, as described hereinbelow with respect to FIGS. 13 and 14, reference to which is now made.

FIG. 13 illustrates the operation of a colorizer 17′ operating independently of shape reconstructor 10. FIG. 14 is a flow chart illustrating the method steps of process COL-I performed by colorizer 17′, in accordance with the present invention, to construct colorized model 27 for an input shape S_{Q}. As described hereinabove with respect to FIGS. 7 and 8, the example objects used in process COL by colorizer 17 may be the final database example objects chosen by examples updater 58 in process SER For independent process COL-I, these example objects may not be available, as process SER may not be performed prior to process COL-I. Therefore, as shown in FIG. 13, colorizer 17′ may comprise, in addition to all of the components of colorizer 17, examples selector 81 for the selection of example objects. Similarly, as shown in FIG. 14, independent colorization process COL-I may comprise all of the method steps of process COL performed by colorizer 17, with the addition of method step COL-0 for the selection of example objects.

In method step COL-0, which may be the first method step performed by colorizer 17′, examples selector 81 may choose a small subset of database S to provide reference examples for colorization process COL-I. In one embodiment of the present invention, examples selector 81 may choose the m mappings Mᵢ with the most similar depth map to D (i.e., minimal (D-Dᵢ)², D and Dᵢ centroid aligned), where m<<|S|. Examples selector 81 may also select examples which have similar intensities so that the resultant color of colorized model 27 is not mottled. In an alternative embodiment of the present invention, a human modeler may manually select specific reference examples having desired image-maps.

It will further be appreciated that colorizer 17′ may not be limited to creating image maps of color. Rather, colorizer 17′ may create maps of other surface properties such as albedos, vector fields and displacement maps, so long as the examples in the database have the desired surface property.

In an additional preferred embodiment of the present invention, refined shape reconstructor 19 may operate as an independent apparatus, rather than as a component of shape reconstructor 10. Refined shape reconstructor 19 may be used to recover 3D shape and albedo of faces from an input image of a face, as described hereinabove with respect to FIGS. 9 and 10, by using a single reference model of a different individual.

It will be appreciated that in the embodiment of the present invention described with respect to FIGS. 9 and 10, where refined shape reconstructor 19 is a component of shape reconstructor 10, and process COL, performed by colorizer 17, which produces colorized model 27 FIGS. 7 and 8), precedes process RSR performed by refined shape reconstructor 19, the single reference model used by refined shape reconstructor 19 may be colorized model 27. However, it will be appreciated that any model of a face, i.e., any reference model, may be utilized in process RSR as colorized model 27.

It will further be appreciated that process RSR performed by refined shape reconstructor 19 does not establish correspondence between symmetric portions of a face, nor does it store a database of many faces with point correspondences across the faces. Instead, the method provided in the present invention may use a single reference model to exploit the global similarity of faces, and thereby provide the missing information which is required to solve a shape from shading problem in order to perform shape recovery.

It will further be appreciated that the method provided in the present invention may substantially accurately recover the shape of faces while overcoming significant differences of race, gender and variations in expressions among different individuals. The method provided in the present invention may also handle a variety of uncontrolled lighting conditions, and achieve consistent reconstructions with different reference models.

Experiments using a database containing depth and texture maps of 56 real faces (male and female adult faces with a mixture of race and age) obtained with a laser scanner were performed. For albedos of the reference models, each texture map of the texture maps provided in the database was averaged with its mirror image, in order to reduce the effects of the lighting conditions.

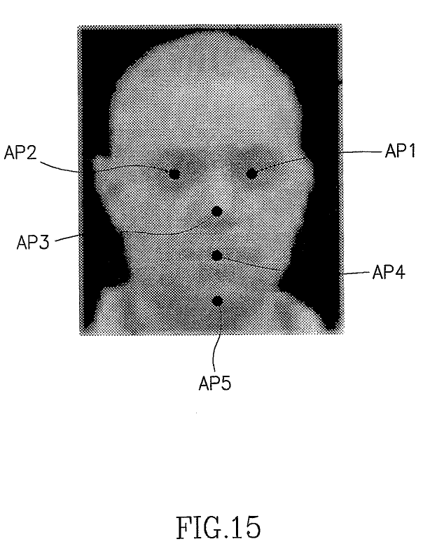

Furthermore, the following parameters were used: The reference albedo was kept in the range between 0 and 255. Both λ₁ and λ₂ were set to 110. The reference albedo was smoothed by a 2-D Gaussian with σₓ=3 and σ_{y}=4. The same smoothing parameters were used for the two regularization terms. Finally, the query images were aligned with the reference models by marking five corresponding points, AP1-AP5, on the image and the reference model, as shown in FIG. 15, reference to which is now made. As shown in FIG. 15, points AP1 and AP2 are at the centers of the eyes, point AP3 is on the tip of the nose, point AP4 is in the center of the mouth and point AP5 is at the bottom of the chin. These points of correspondence were then used to determine a 2D rotation, translation, and scale to fit each query image I_{Q} to its reference model. After alignment, all the images contained 150×200 pixels. Depth recoverer 104 recovered depth by directly solving a system of linear equations.

Using artificially rendered images I_{QA} of faces from the database, Applicants were able to compare the actual shapes GT (ground truth shapes) of these faces with the reconstructed shapes 35 produced by the present invention. The artificially rendered images I_{QA} were produced by illuminating a model by 2-3 point sources from directions lᵢ and with intensity Lᵢ. The intensities reflected by the surface due to this light are given by:

$$I = {\sum }_{i = 1}^{n} ρ {L}_{i} max ( cos ( {n}^{T} {1}_{i} ) , 0 ) .$$

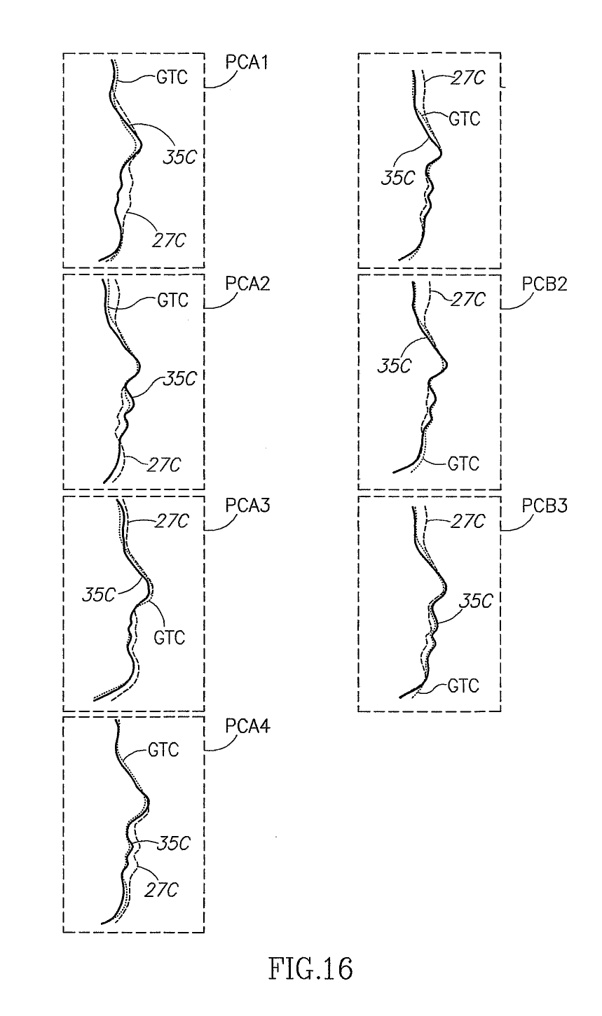

FIG. 16, reference to which is now made, shows exemplary profile comparisons PCA1-PCA4 and PCB1-PCB3 for exemplary reconstructions of artificially rendered images I_{QA}. Each of profile comparisons PCA1-PCA4 and PCB1-PCB3 shows for one reconstruction result of an artificially rendered image I_{QA}, a profile curve 35C of recovered shape 35 (solid line) overlaid on a profile curve GTC of ground truth shape GT (dotted line) and a profile curve 27C of reference model 27 (dashed line). The close correspondence of profile curves 35C and GTC of recovered shapes 35 and ground truth shapes GT respectively, for each reconstruction represented in FIG. 16 by profile comparisons PCA1-PCA4 and PCB1-PCB3 demonstrates the capability of the present invention to produce fairly accurate reconstructions.

The close correspondence of profile curves 35C and GTC in profile comparison PCA3 in FIG. 16 further demonstrates that the present invention may obtain fairly accurate reconstructions in spite of gender differences, since for the reconstruction of profile comparison PCA3, the individual in input image I_{QA} was male, while reference model 27 was female.

The close correspondence of profile curves 35C and GTC in profile comparisons PCA1 and PCA4 in FIG. 16 further demonstrates that the present invention may obtain fairly accurate reconstructions in spite of racial differences, since for the reconstructions of profile comparisons PCA1 and PCA4, the individuals in the input images I_{QA} were of a different race than reference models 27.

The robustness of the algorithm provided in the present invention is further demonstrated by the consistent similarity between recovered shapes 35 and ground truth shapes GT as demonstrated in profile comparisons PCB1, PCB2 and PCB3 in FIG. 16. For the reconstructions of profile comparisons PCB1, PCB2 and PCB3, the same input image I_{QA} was used, while different reference models 27 were used.

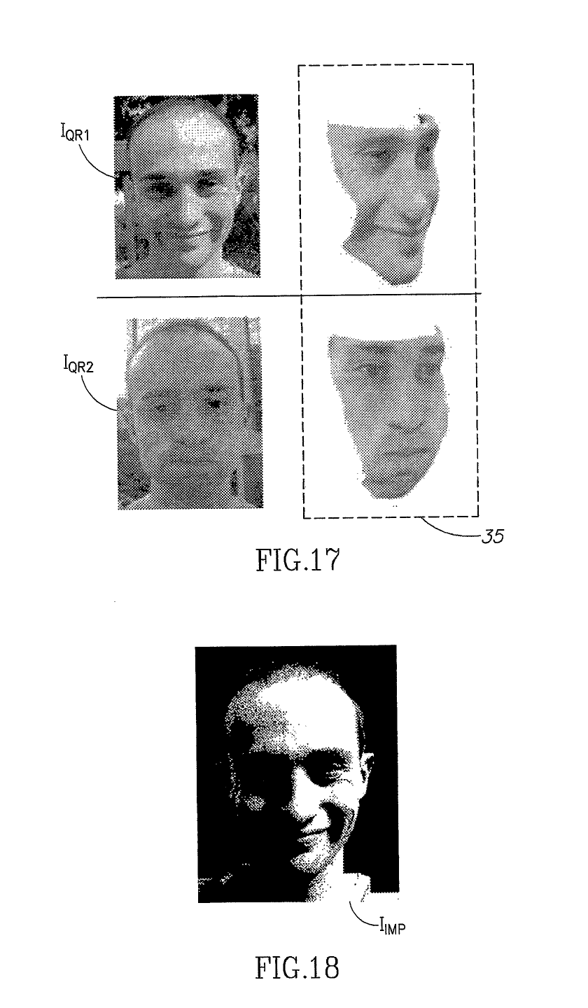

FIG. 17 shows exemplary reconstruction results for real images I_{QR1} and I_{QR2} which contain facial expressions. As shown in FIG. 17, fairly convincing shape reconstructions 35 were obtained for images I_{QR1} and I_{QR2}, demonstrating the capability of the present invention to generally faithfully reconstruct various facial expressions.

The present invention may further be capable of reconstructing faces from images containing impoverished data, such as image I_{IMP} shown in FIG. 18, reference to which is now made. Two-tone images of faces containing very little visual detail, such as image I_{IMP} of FIG. 18, are commonly known as Mooney faces, since a notable use of this type of image is attributed to the cognitive psychologist Craig Mooney, who tested the ability of children to form a coherent perceptual impression on the basis of very little visual detail. Over the years, psychologists and neuroscientists found that indeed in many cases very little visual information may suffice to experience a face, and at the same time to notice the variety of other shapes and contours that emerge.

Very few computational models have been proposed to explain this phenomenon. Most notably Shashua (On photometric issues in 3d visual recognition from a single 2d image. International Journal of Computer Vision, 21:99-122, 1997) introduced a method for face recognition from a single Mooney image from a fixed pose. This method, however, required a 3D model of the specific individual to be identified in the image, i.e., it assumes knowledge of the individual present in the image, and so it cannot explain human perception of novel faces in Mooney images. In contrast, the algorithm provided in the present invention may be used to recover the 3D shape of a novel face appearing in a single Mooney image.

It will further be appreciated that the present invention may also be used to reconstruct the 3D shape of a non-frontal image.

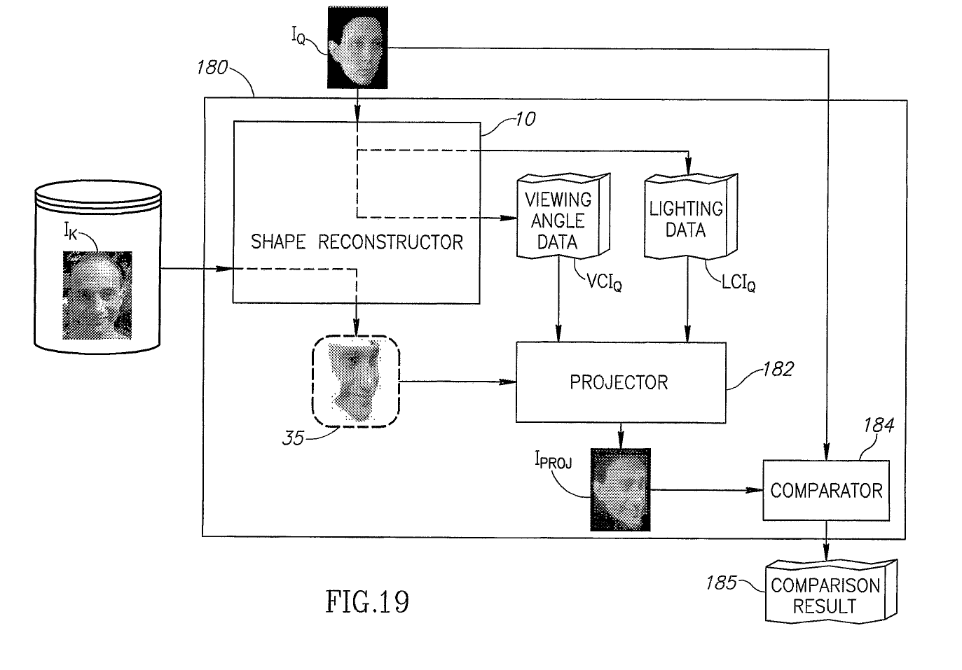

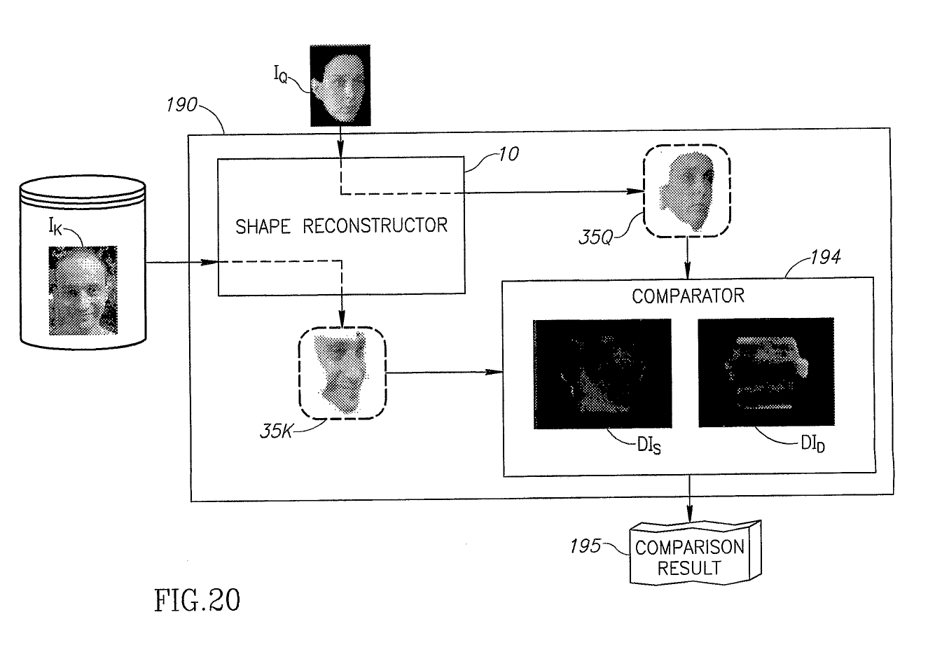

Reference is now made to FIGS. 19 and 20 which show how the present invention may be employed for recognition. Given a stored image I_{K} of an individual whose identity is known, and a query image I_{Q}, a recognizer 180, constructed and operative in accordance with a preferred embodiment of the present invention, may determine if the identity of the individual in image I_{Q} is the same as that of the individual in image I_{K}.

As shown in FIG. 19, recognizer 180 may comprise shape reconstructor 10, projector 182 and comparator 184. Shape reconstructor 10 may perform reconstruction tasks on both images I_{K} and I_{Q}. Specifically, shape reconstructor 10 may produce shape reconstruction 35 for image I_{K}, and determine the lighting and viewing conditions (LCI_{Q} and VCI_{Q} respectively) for image I_{Q}. Projector 182 may then project 3D shape reconstruction 35 at lighting conditions LCI_{Q} and viewing angle conditions VCI_{Q} to generate 2D projected image I_{PROJ}. Comparator 184 may then compare 2D images I_{Q} and I_{PROJ} using least squares, or any other suitable method of comparison, thereby determining comparison result 185.

If comparator 184 finds images I_{Q} and I_{PROJ} to be sufficiently similar, comparison result 185 may indicate that the identity of the individual in image I_{Q} is the same as the identity of the individual in image I_{K}. Conversely, if comparator 184 finds images I_{Q} and I_{PROJ} to be sufficiently dissimilar, comparison result 185 may indicate that the identity of the individual in image I_{Q} is not the same as that of the individual in image I_{K}.

FIG. 20 shows an additional embodiment of the present invention which may be used for recognition. Images I_{K} and I_{Q} may be as defined in FIG. 19, and recognizer 190, constructed and operative in accordance with an additional preferred embodiment of the present invention, may determine if the identity of the individual in image I_{Q} is the same as that of the individual in image I_{K}.

As shown in FIG. 20, recognizer 190 may comprise shape reconstructor 10 and comparator 194. As in the embodiment of FIG. 19, shape reconstructor 10 may perform reconstruction tasks on both images I_{K} and I_{Q}. However, in the embodiment of FIG. 20, shape reconstructor 10 may produce shape reconstruction 35 for both images I_{K} and I_{Q}, rather than only for image I_{K} as in the embodiment of FIG. 19. Exemplary shape reconstructions 35K and 35Q are shown in FIG. 20 to be the reconstructed shapes of images I_{K} and I_{Q} respectively. Comparator 194 may then compare the two 3D shape reconstructions 35 (i.e., shape reconstructions 35K and 35Q) and determine comparison results 195.

In accordance with the present invention, comparator 194 may use a difference image, of depth, surface normals or any other suitable parameter, in order to compare shape reconstructions 35K and 35Q. Two exemplary difference images, DI_{S} and DI_{D}, are shown in FIG. 20.

As in the embodiment of FIG. 19, if comparator 194 finds shape reconstructions 35K and 35Q to be sufficiently similar, comparison result 195 may indicate that the identity of the individual in image k is the same as that of the individual in image I_{K}. Exemplary difference image DI_{S}, with its monochromatic appearance, indicating little difference between shape reconstructions 35K and 35Q, is indicative of this outcome.

Also as in the embodiment of FIG. 19, if comparator 194 finds 3D shape reconstructions 35K and 35Q to be sufficiently dissimilar, comparison result 195 may indicate that the identity of the individual in image k is not the same as that of the individual in image I_{K}. Exemplary difference image DI_{D}, with its variegated shading, indicating significant differences between shape reconstructions 35K and 35Q, is indicative of this outcome.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method comprising:
given an input image, a collection of example 3D objects and their colors, reconstructing the 3D shape of an object appearing in said input image using at least one of said example objects.

2. The method according to claim 1 and wherein said reconstructing comprises:
seeking patches of said at least one example object that match patches in said input image in appearance;
producing an initial depth map from the depths associated with said matching patches; and
refining said initial depth map to produce said reconstructed shape.

3. The method according to claim 2 and wherein said seeking comprises searching for patches whose appearance match said patches in said input image in accordance with a similarity measure.

4. The method according to claim 3 and wherein said similarity measure is least squares.

5. The method according to claim 2 and also comprising customizing a set of objects from said collection for use in said seeking.

6. The method according to claim 5 and wherein said customizing comprises:
arbitrarily selecting a set of objects from said collection;
updating said set of objects, wherein said updating comprises:
dropping objects from said set which have the least number of matched patches;
scanning the remainder of objects in said collection to find those whose depth maps best match a current depth map; and
repeating said updating.

7. The method according to claim 1 and wherein said reconstructing determines the viewing angle of said input image.

8. The method according to claim 7 and wherein said reconstructing comprises:
for at least one object from a current set of objects, rendering said object viewed from at least two different viewing conditions;
dropping objects from said current set which correspond least well to said input image;
producing a new viewing condition based on the viewing conditions of objects which correspond well to said input image;
rendering said object viewed from said new viewing condition; and
repeating said steps of dropping, producing and rendering.

9. The method according to claim 8 and wherein said producing comprises taking a mean of currently used viewing conditions weighted by the number of matched patches of each viewing condition.

10. The method according to claim 2 and wherein said producing comprises:
seeking at least one matching patch for each patch in said input image;
extracting a corresponding depth patch for each matched patch; and
producing said initial depth map by, for each pixel, compiling the depth values associated with said pixel in said corresponding depth patches of the matched patches which contain said pixel.

11. The method according to claim 10 and wherein said refining comprises:
having query color-depth mappings each formed of one of said image patches and its associated depth patch of a current depth map;
seeking at least one matching color-depth mapping for each said query color-depth mapping;
extracting a corresponding depth patch for each matched patch;
producing a next current depth map by, for each pixel, compiling the depth values associated with said pixel in said corresponding depth patches of the matched patches which contain said pixel; and
repeating said having, seeking, extracting and producing until said next current depth map is not significantly different than said previous current depth map to generate said reconstructed shape.

12. The method according to claim 1 and wherein said object of said input image is a face and wherein said at least one example object is one example object of an individual whose face is different than that shown in said input image.

13. The method according to claim 12 and wherein said reconstructing comprises:
recovering lighting parameters to fit said one example object to said input image;
solving for depth of said object of said input image using said recovered lighting parameters and albedo estimates for said example object; and
estimating albedo of said object of said input image using said recovered lighting parameters and said depth.

14. The method according to claim 13 and wherein said recovering, solving and estimating utilize an optimization function in which reflectance is expressed using spherical harmonics.

15. The method according to claim 13 and wherein said solving comprises solving a shape from shading problem.

16. The method according to claim 15 and wherein boundary conditions for said solving are incorporated in an optimization function.

17. The method according to claim 15 and wherein said shape from shading problem is linearized.

18. The method according to claim 16 and wherein said optimization function is linearized using said example object.

19. The method according to claim 15 and wherein unknowns in said shape from shading problem are provided by said example object.

20. The method according to claim 13 and wherein said face of said input image has a different expression than that of said example object.

21. The method according to claim 13 and wherein said input image is a degraded image.

22. The method according to claim 21 and wherein said degraded image is a Mooney face image.

23. The method according to claim 13 and wherein said input image is one of a frontal image and a non-frontal image.

24. The method according to claim 13 and wherein said input image is one of a color image and a grey scale image.

25. The method according to claim 1 and also comprising:
repeating said reconstructing on a second input image to generate viewing conditions of said second input image;
projecting said viewing conditions onto said reconstructed shape to generate a projected image; and
determining if said projected image is substantially the same as said second input image.

26. The method according to claim 1 and also comprising:
repeating said reconstructing on a second input image to generate a second object; and
determining if said second object is substantially the same as said first object.

27. A method comprising:
stripping an input image of viewing conditions to reveal a shape of an object in said input image.

28. The method according to claim 27 and also comprising:
performing said stripping on two input images; and
comparing said revealed shapes of said two input images.

29. A method comprising:
providing surface properties to an input 3D object from the surface properties of a collection of example objects.

30. The method according to claim 29 and wherein said providing comprises:
seeking patches of said example objects that match patches in said input 3D object in depth;
producing an initial image map from surface properties associated with said matching patches; and
refining said initial image map to produce a model with surface properties.

31. The method according to claim 29 and wherein said surface properties are one of the following surface properties: colors, albedos, vector fields and displacement maps.

32. A method comprising:
having an input image and a collection of example 3D objects;
calculating a shape estimate using said input image and at least one of said example objects;
colorizing said shape estimate using color of at least one of said example objects to produce a colorized model; and
employing said input image and said colorized model to refine said shape estimate to generate a reconstructed shape of said input image.

33. A method comprising:
given an input image, a collection of example 3D objects and their colors, using at least one of said example objects to reconstruct, for an object appearing in said input image, a 3D shape of an occluded portion of said object.

34. The method according to claim 33 and wherein said using comprises:
generating a 3D shape of a visible portion of said object in said input image; and
generating said occluded portion shape from said visible portion shape and at least one example object.

35. An apparatus comprising:
a reconstructor to reconstruct the 3D shape of an object appearing in an input image using at least one example object of a collection of example 3D objects and their colors.

36. The apparatus according to claim 35 and wherein said reconstructor comprises:
a seeker to seek patches of said at least one example object that match patches in said input image in appearance;
a producer to produce an initial depth map from the depths associated with said matcher patches; and
a refiner to refine said initial depth map to produce said reconstructed shape.

37. The apparatus according to claim 36 and wherein said seeker comprises a searcher to search for patches whose appearance match said patches in said input image in accordance with a similarity measure.

38. The apparatus according to claim 37 and wherein said similarity measure is least squares.

39. The apparatus according to claim 36 and also comprising a customizer to customize a set of objects from said collection for use in said seeker.

40. The apparatus according to claim 39 and wherein said customizer comprises:
a selector to arbitrarily select a set of objects from said collection; and
an updater to update said set of objects by dropping objects from said set which have the least number of matched patches and scanning the remainder of objects in said collection to find those whose depth maps best match a current depth map.

41. The apparatus according to claim 35 and wherein said reconstructor determines the viewing angle of said input image.

42. The apparatus according to claim 41 and wherein said reconstructor comprises:
a renderer to render, for at least one object from a current set of objects, said object viewed from at least two different viewing conditions;
an object updater to drop objects from said current set which correspond least well to said input image; and
a producer to produce a new viewing condition based on the viewing conditions of objects which correspond well to said input image.

43. The apparatus according to claim 42 and wherein said producer comprises a weighted to take a mean of currently used viewing conditions weighted by the number of matched patches of each viewing condition.

44. The apparatus according to claim 36 and wherein said producer comprises:
a seeker to seek at least one matching patch for each patch in said input image;
an extractor to extract a corresponding depth patch for each matched patch; and
a producer to produce said initial depth map by, for each pixel, compiling the depth values associated with said pixel in said corresponding depth patches of the matched patches which contain said pixel.

45. The apparatus according to claim 44 and wherein said refiner comprises:
a seeker to seek at least one matching color-depth mapping, formed of one of said image patches and its associated depth patch of a current depth map, for a query color-depth mapping;
an extractor to extract a corresponding depth patch for each matched patch;
a producer to produce a next current depth map by, for each pixel, compiling the depth values associated with said pixel in said corresponding depth patches of the matched patches which contain said pixel; and
a determiner to operate said seeker, extractor and producer until said next current depth map is not significantly different than said previous current depth map thereby to generate said reconstructed shape.

46. The apparatus according to claim 35 and wherein said object of said input image is a face and wherein said at least one example object is one example object of an individual whose face is different than that shown in said input image.

47. The apparatus according to claim 46 and wherein said reconstructor comprises:
a lighting recoverer to recover lighting parameters to fit said one example object to said input image;
a solver to solve for depth of said object of said input image using said recovered lighting parameters and albedo estimates for said example object; and
an albedo estimator to estimate albedo of said object of said input image using said recovered lighting parameters and said depth.

48. The apparatus according to claim 47 and wherein said recoverer, solver and estimator utilize an optimization function in which reflectance is expressed user spherical harmonics.

49. The apparatus according to claim 47 and wherein said solver comprises a shape from shading problem solver.

50. The apparatus according to claim 49 and wherein boundary conditions for said solver are incorporated in an optimization function.

51. The apparatus according to claim 49 and wherein said shape from shading problem is linearized.

52. The apparatus according to claim 50 and wherein said optimization function is linearized using said example object.

53. The apparatus according to claim 49 and wherein unknowns in said shape from shading problem are provided by said example object.

54. The apparatus according to claim 47 and wherein said face of said input image has a different expression than that of said example object.

55. The apparatus according to claim 47 and wherein said input image is a degraded image.

56. The apparatus according to claim 55 and wherein said degraded image is a Mooney face image.

57. The apparatus according to claim 47 and wherein said input image is one of a frontal image and a non-frontal image.

58. The apparatus according to claim 47 and wherein said input image is one of a color image and a grey scale image.

59. The apparatus according to claim 35 and also comprising:
a recognizer to operate said reconstructor on a second input image to generate viewing conditions of said second input image, to project said viewing conditions onto said reconstructed shape to generate a projected image and to determine if said projected image is substantially the same as said second input image.

60. The apparatus according to claim 35 and also comprising:
a recognizer to operate said reconstructor on a second input image to generate a second object and to determine if said second object is substantially the same as said first object.

61. An apparatus comprising:
a stripper to strip an input image of viewing conditions to reveal a shape of an object in said input image.

62. The apparatus according to claim 61 and also comprising:
a recognizer to operate said stripper on two input images and to compare said revealed shapes of said two input images.

63. An apparatus comprising:
a storage unit to store a collection of example objects; and
a unit to provide surface properties to an input 3D object from the surface properties of said collection.

64. The apparatus according to claim 63 and wherein said unit comprises:
a seeker to seek patches of said example objects that match patches in said input 3D object in depth;
a producer to produce an initial image map from surface properties associated with said matcher patches; and
a refiner to refine said initial image map to produce a model with surface properties.

65. The apparatus according to claim 63 and wherein said surface properties are one of the follower surface properties: colors, albedos, vector fields and displacement maps.

66. An apparatus comprising:
an estimator to calculate a shape estimate using an input image and at least one example object of a collection of example 3D objects;
a colorizer to color said shape estimate using color of at least one of said example objects to produce a colorized model; and
a shape refiner to employ said input image and said colorized model to refine said shape estimate to generate a reconstructed shape of said input image.

67. An apparatus comprising:
a reconstructor to reconstruct, for an object appearing in an input image, a 3D shape of an occluded portion of said object using at least one example object of a collection of example 3D objects and their colors.

68. The apparatus according to claim 67 and wherein said reconstructor comprises:
a generater to generate a 3D shape of a visible portion of said object in said input image; and
a generater to generate said occluded portion shape from said visible portion shape and at least one example object.
